(19) United States
(12) Patent Application Publication
(10) Pub. No.: US 2026/0025014 A1
(43) Pub. Date: Jan. 22, 2026

(54) BATTERY SWITCHING DEVICE

(71) Applicant: YAZAKI CORPORATION, Tokyo (JP)

(72) Inventor: Hiroo YABE, Shizuoka (JP)

(73) Assignee: YAZAKI CORPORATION, Tokyo (JP)

(21) Appl. No.: 19/239,356

(22) Filed: Jun. 16, 2025

(30) Foreign Application Priority Data
Jul. 17, 2024 (JP) 2024-113820

(51) Int. Cl. H02J 7/00; H01M 50/269; H01M 50/583

(52) U.S. Cl. CPC H02J 7/0029; H01M 50/269; H01M 50/583; H02J 7/0024; H01M 2200/103

(57) ABSTRACT

There is provided a battery switching device including: a first contact device including a first movable contact and a first parallel contact to which the first movable contact is connected or disconnected; and a second contact device including a second movable contact, a series contact to which the second movable contact is connected or disconnected, and a second parallel contact to which the second movable contact is connected or disconnected; and a connection restriction unit configured to prevent the second movable contact from being connected to the series contact in a state where the first movable contact is connected to the first parallel contact and prevent the first movable contact from being connected to the first parallel contact in a state where the second movable contact is connected to the series contact.

### CROSS-REFERENCE TO RELATED APPLICATIONS

This application is based on and claims priority under 35 USC 119 from Japanese Patent Application No. 2024-113820 filed on Jul. 17, 2024, the contents of which are incorporated herein by reference.

### TECHNICAL FIELD

The present disclosure relates to a battery switching device.

### BACKGROUND ART

A power supply device that switches a connection state of a pair of batteries between series connection and parallel connection is known (for example, see JPS58-56550U, JP2020-089111A, WO2022/172633A1, and JP2021-191080A).

In a power supply device described in JPS58-56550U, JP2020-089111A, and WO2022/172633A1, switching between series connection and parallel connection of a pair of batteries is performed by one changeover-contact switch and one arbeit-contact switch or break-contact switch. In a power supply device described in JP2021-191080A, series connection and parallel connection of a pair of batteries are switched by one relay.

In the power supply device described in JPS58-56550U, JP2020-089111A, and WO2022/172633A1, when the switch or the relay is fixed, the battery may be short-circuited. In the power supply device described in JP2021-191080A, when a movable body that is moved by energization of a coil is retracted to a neutral position and the pair of batteries are in a non-energized state, the contacts of the relay face each other with a space therebetween. Therefore, when the relay is deformed by an external force, the contacts may come into contact with each other, and the battery may be short-circuited.

### SUMMARY OF INVENTION

The present disclosure provides a battery switching device with improved safety.

According to an illustrative aspect of the present disclosure, a battery switching device includes: a first contact device including a first movable contact and a first parallel contact to which the first movable contact is connected or disconnected; and a second contact device including a second movable contact, a series contact to which the second movable contact is connected or disconnected, and a second parallel contact to which the second movable contact is connected or disconnected. A first battery and a second battery are connected in series by disconnecting the first movable contact from the first parallel contact, disconnecting the second movable contact from the second parallel contact, and connecting the second movable contact to the series contact. The first battery and the second battery are connected in parallel by connecting the first movable contact and the first parallel contact, connecting the second movable contact and the second parallel contact, and disconnecting the second movable contact and the series contact. The first movable contact includes a first conductor bar provided to be linearly movable along an axial direction and provided with a first male contact at one end in the axial direction. The first parallel contact is a female contact to which the first male contact is connected or separated by linear movement of the first conductor bar. The second movable contact includes a second conductor bar provided to be linearly movable along the axial direction and provided with a second male contact at one end in the axial direction and a third male contact at the other end in the axial direction. The series contact is a female contact to which the second male contact is connected or separated by linear movement of the second conductor bar. The second parallel contact is a female contact to which the third male contact is connected or separated by linear movement of the second conductor bar. The battery switching device further includes a connection restriction unit configured to prevent the second male contact from being connected to the series contact in a state where the first male contact is connected to the first parallel contact and prevent the first male contact from being connected to the first parallel contact in a state where the second male contact is connected to the series contact.

### BRIEF DESCRIPTION OF DRAWINGS

FIG. 1 is a circuit diagram showing a battery switching device according to an embodiment of the present disclosure and a battery system including the battery switching device;

FIG. 2 shows the battery switching device shown in FIG. 1;

FIG. 3 shows an operation of the battery switching device shown in FIG. 2;

FIG. 4 shows the operation of the battery switching device shown in FIG. 2;

FIG. 5 shows the operation of the battery switching device shown in FIG. 2;

FIG. 6 shows the operation of the battery system shown in FIG. 1;

FIG. 7 shows the operation of the battery system shown in FIG. 1;

FIG. 8 shows the operation of the battery system shown in FIG. 1;

FIG. 9 shows the operation of the battery system shown in FIG. 1;

FIG. 10 shows an operation of a battery system according to a comparative example;

FIG. 11 is a flowchart illustrating a process performed when connection state between a first battery module and a second battery module is switched from series connection to parallel connection before the start of charging of the first battery module and the second battery module;

FIG. 12 is a diagram showing a battery switching device according to another embodiment of the present disclosure;

FIG. 13 shows an operation of the battery switching device shown in FIG. 12;

FIG. 14 shows the operation of the battery switching device shown in FIG. 12;

FIG. 15 is a diagram showing a battery switching device according to another embodiment of the present disclosure;

FIG. 16 shows an operation of the battery switching device shown in FIG. 15;

FIG. 17 shows the operation of the battery switching device shown in FIG. 15;

FIG. 18 is a diagram showing a battery switching device according to another embodiment of the present disclosure;

FIG. 19 shows an operation of the battery switching device shown in FIG. 18;

FIG. 20 shows the operation of the battery switching device shown in FIG. 18;

FIG. 21 is a diagram showing a battery switching device according to another embodiment of the present disclosure;

FIG. 22 shows an operation of the battery switching device shown in FIG. 21;

FIG. 23 is a circuit diagram showing a contact drive circuit provided in a battery switching device according to another embodiment of the present disclosure;

FIG. 24 shows a configuration for turning ON/OFF a fifth switch shown in FIG. 23;

FIG. 25 shows an operation of the configuration shown in FIG. 24;

FIG. 26 is a circuit diagram showing a battery switching device and a battery system including the battery switching device according to another embodiment of the present disclosure;

FIG. 27 is a circuit diagram showing an operation of the battery system shown in FIG. 26; and

FIG. 28 is a circuit diagram showing a battery switching device and a battery system including the battery switching device according to another embodiment of the present disclosure.

### DESCRIPTION OF EMBODIMENTS

Hereinafter, the present disclosure will be described with reference to preferred embodiments. The present disclosure is not limited to the embodiments to be described below, and the embodiments to be described below can be appropriately changed within a scope not departing from the spirit of the present disclosure. In the embodiments to be described below, a part of configurations may be not described or shown in the drawings, and regarding details of the omitted techniques, publicly known or well-known techniques will be appropriately applied as long as there is no contradiction with the contents to be described below.

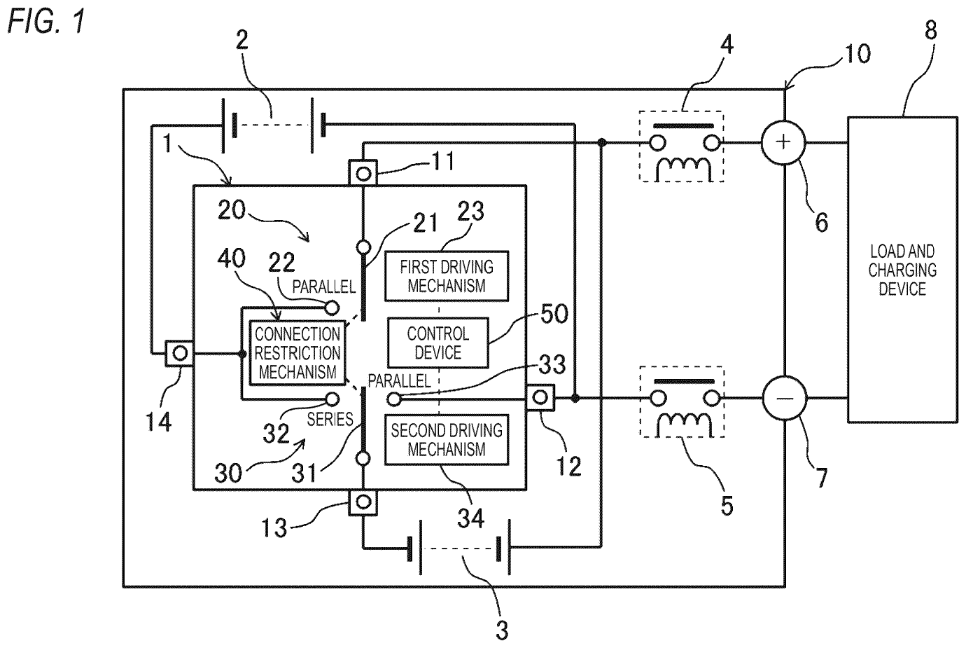

FIG. 1 is a circuit diagram showing a battery switching device 1 according to an embodiment of the present disclosure and a battery system 10 including the battery switching device 1. The battery system 10 shown in this drawing is a battery pack mounted on an electric vehicle, supplies power to a load such as a motor of the electric vehicle, and is charged with power generated by a generator such as the motor of the electric vehicle or charging power of an in-vehicle charger. The applications of the battery system 10 include other applications such as stationary applications.

The battery system 10 includes the battery switching device 1, a first battery module 2, a second battery module 3, a first main relay 4, and a second main relay 5. The first battery module 2 and the second battery module 3 are secondary batteries such as lithium-ion batteries, and can input and output the same voltage to and from each other.

The battery switching device 1 is a series-parallel switching device that switches a connection state between the first battery module 2 and the second battery module 3 between series connection and parallel connection, and includes a first contact device 20, a second contact device 30, a connection restriction mechanism 40, and a control device 50. The control device 50 controls the first contact device 20 and the second contact device 30 in accordance with an instruction from a control device (not shown) on an electric vehicle side.

The battery switching device 1 includes a first terminal 11, a second terminal 12, a third terminal 13, and a fourth terminal 14. The first terminal 11 is connected to the first main relay 4. The first main relay 4 is connected to a load and charging device 8 via a positive terminal 6 of the battery system 10. The second terminal 12 is connected to the second main relay 5. The second main relay 5 is connected to the load and charging device 8 via a negative terminal 7 of the battery system 10.

The third terminal 13 is connected to a negative electrode of the second battery module 3. A positive electrode of the second battery module 3 is connected to a power line that connects the first main relay 4 and the first terminal 11. The fourth terminal 14 is connected to a positive electrode of the first battery module 2. A negative electrode of the first battery module 2 is connected to a power line that connects the second main relay 5 and the second terminal 12.

The first contact device 20 includes a first movable contact 21, a first parallel contact 22, and a first driving mechanism 23. The first movable contact 21 is a movable contact connected to the first terminal 11 and is capable of approaching and separating from the first parallel contact 22. The first parallel contact 22 is a fixed contact connected to the fourth terminal 14. When the first movable contact 21 comes into contact with the first parallel contact 22, the first terminal 11 is connected to the fourth terminal 14, and when the first movable contact 21 is separated from the first parallel contact 22, the first terminal 11 and the fourth terminal 14 are disconnected.

The first driving mechanism 23 moves the first movable contact 21 between a parallel connection position where the first movable contact 21 and the first parallel contact 22 are in contact with each other and a disconnection position where the first movable contact 21 is separated from the first parallel contact 22. Details of the first driving mechanism 23 will be described later.

The second contact device 30 includes a second movable contact 31, a series contact 32, a second parallel contact 33, and a second driving mechanism 34. The second movable contact 31 is a movable contact connected to the third terminal 13, and is capable of approaching and separating from the series contact 32 and the second parallel contact 33. The series contact 32 is a fixed contact connected to the fourth terminal 14 and the first parallel contact 22. The second parallel contact 33 is a fixed contact connected to the second terminal 12.

When the second movable contact 31 comes into contact with the series contact 32, the third terminal 13 and the fourth terminal 14 are connected, and when the second movable contact 31 is separated from the series contact 32, the third terminal 13 and the fourth terminal 14 are disconnected. On the other hand, when the second movable contact 31 comes into contact with the second parallel contact 33, the second terminal 12 and the third terminal 13 are connected, and when the second movable contact 31 is separated from the second parallel contact 33, the second terminal 12 and the third terminal 13 are disconnected.

The second driving mechanism 34 moves the second movable contact 31 between a series connection position where the second movable contact 31 and the series contact 32 are in contact with each other and a parallel connection position where the second movable contact 31 and the second parallel contact 33 are in contact with each other. Details of the second driving mechanism 34 will be described later.

The first parallel contact 22 and the second parallel contact 33 are contacts for connecting the first battery module 2 and the second battery module 3 in parallel. The first battery module 2 and the second battery module 3 are connected in parallel in a state where the first movable contact 21 is in contact with the first parallel contact 22, the second movable contact 31 is in contact with the second parallel contact 33, and the second movable contact 31 is separated from the series contact 32.

The series contact 32 is a contact for connecting the first battery module 2 and the second battery module 3 in series. The first battery module 2 and the second battery module 3 are connected in series in a state where the first movable contact 21 is separated from the first parallel contact 22, the second movable contact 31 is separated from the second parallel contact 33, and the second movable contact 31 is in contact with the series contact 32.

The connection restriction mechanism 40 is a mechanism that prevents the contact between the first movable contact 21 and the first parallel contact 22 and the contact between the second movable contact 31 and the series contact 32 from occurring simultaneously. The connection restriction mechanism 40 prevents the second movable contact 31 from moving toward the series contact 32 in a state where the first movable contact 21 is in contact with the first parallel contact 22. The connection restriction mechanism 40 prevents the first movable contact 21 from moving toward the first parallel contact 22 in a state where the second movable contact 31 is in contact with the series contact 32. Details of the connection restriction mechanism 40 will be described later.

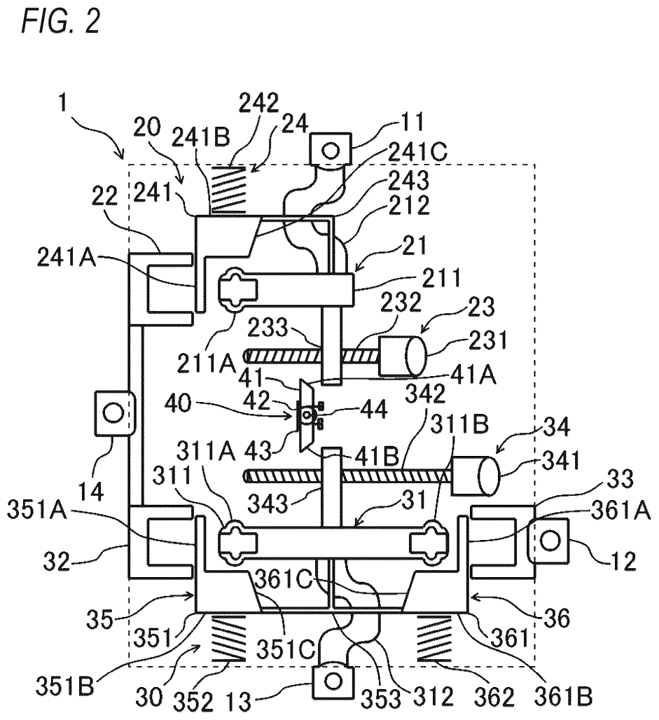

FIG. 2 is a diagram showing the battery switching device 1 shown in FIG. 1. As shown in this drawing, the first parallel contact 22 and the series contact 32 are arranged in a direction (an up-down direction in the drawing) orthogonal to a movement direction of a first conductor bar 211 and a second conductor bar 311 to be described later. The series contact 32 and the second parallel contact 33 are arranged in the movement direction (a left-right direction in the drawing) of the first conductor bar 211 and the second conductor bar 311.

The first movable contact 21 includes the first conductor bar 211 and the first conductor 212. The first conductor bar 211 is a rod-shaped conductor. A first male contact 211A is provided on one end side in an axial direction of the first conductor bar 211. The first conductor bar 211 is supported by a support unit (not shown) to be movable along the axial direction of the first conductor bar 211, and is moved in both directions by the first driving mechanism 23.

The first conductor 212 is a conductor having flexibility or tensile strength such as an electric wire or a flexible printed wiring board. One end of the first conductor 212 is connected to the first terminal 11, and the other end of the first conductor 212 is connected to the other end side in the axial direction of the first conductor bar 211. The first conductor 212 is deformed or displaced following the movement of the first conductor bar 211 in the axial direction.

The first parallel contact 22 is a female-side contact to which the first male contact 211A of the first conductor bar 211 is fitted. The first parallel contact 22, the series contact 32, and the fourth terminal 14 are integrally formed of a conductive material.

The first driving mechanism 23 includes a first motor 231, a first ball screw 232, a first slider 233, and a first shielding mechanism 24. The first ball screw 232 is disposed parallel to the first conductor bar 211 and rotates about an axis by a driving force of the first motor 231. The first ball screw 232 may be formed integrally with an output shaft of the first motor 231, or may be coupled to an output shaft of the first motor 231 via a worm gear.

The first slider 233 is fixed to the other end side in the axial direction of the first conductor bar 211 and is screwed to a screw portion of the first ball screw 232. Accordingly, a rotational force of the first motor 231 is converted into power in the axial direction of the first conductor bar 211 via the first ball screw 232 and the first slider 233.

When the first ball screw 232 is rotated in one direction by the first motor 231, the first conductor bar 211 moves toward the first parallel contact 22, and the first male contact 211A is fitted to the first parallel contact 22. On the other hand, when the first ball screw 232 is rotated in the other direction by the first motor 231, the first conductor bar 211 moves to a side separated from the first parallel contact 22, and the fitting between the first male contact 211A and the first parallel contact 22 is released.

The first shielding mechanism 24 includes a first shielding member 241, a first biasing member 242, and a first transmission member 243. The first shielding member 241 is an insulator and is provided to be movable between a shielding position for shielding the first parallel contact 22 and an open position for opening the first parallel contact 22. A movement direction of the first shielding member 241 is a direction (the up-down direction in the drawing) orthogonal to the movement direction of the first conductor bar 211.

The first shielding member 241 includes a first shielding portion 241A, a first attachment portion 241B, and a first tapered portion 241C. The first shielding portion 241A is a plate-shaped portion that opens and closes an opening of the first parallel contact 22, and is disposed at a right angle to the axial direction of the first conductor bar 211. The first attachment portion 241B is a flat surface to which the first biasing member 242 is attached. The first tapered portion 241C is an inclined surface with which the first transmission member 243 is in contact. The first attachment portion 241B and the first tapered portion 241C are provided in a trapezoidal block when viewed in a front-rear direction in the drawing, the first attachment portion 241B constitutes an upper side surface of the block in the drawing, and the first tapered portion 241C constitutes a right side inclined surface of the block in the drawing. The first shielding portion 241A extends between the first male contact 211A and the first parallel contact 22 from lower and left corners of the block in the drawing.

The first biasing member 242 is an elastic member such as a spring. One end of the first biasing member 242 is attached to the first attachment portion 241B, and the other end of the first biasing member 242 is attached to a surface facing the first attachment portion 241B in the up-down direction in the drawing. The first biasing member 242 biases the first shielding member 241 toward the first male contact 211A (a lower side in the drawing).

The first transmission member 243 is a plate-shaped or rod-shaped insulator bent in an L shape. The first transmission member 243 is divided into a horizontal portion and a vertical portion with a bent portion as a boundary. The horizontal portion of the first transmission member 243 is parallel to the axial direction of the first conductor bar 211, and the vertical portion of the first transmission member 243 is perpendicular to the axial direction of the first conductor bar 211. A tip (lower end in the drawing) of the vertical portion of the first transmission member 243 is fixed to the other end side in the axial direction of the first conductor bar 211. On the other hand, a tip (a left end in the drawing) of the horizontal portion of the first transmission member 243 is in contact with the first tapered portion 241C of the first shielding member 241.

The first tapered portion 241C is provided to be inclined from the first parallel contact 22 toward the first transmission member 243 (from the left side in the drawing to the right side in the drawing) from the first shielding portion 241A toward the first attachment portion 241B (from the lower side in the drawing to the upper side in the drawing). The first tapered portion 241C and the first transmission member 243 are pressed against each other by the first biasing member 242. In a state where the first shielding portion 241A shields the opening of the first parallel contact 22, the tip of the horizontal portion of the first transmission member 243 is in contact with an upper end of the first tapered portion 241C in the drawing.

When the first conductor bar 211 moves toward the first parallel contact 22 (a left side in the drawing), the first transmission member 243 advances toward the first parallel contact 22, so that the power of the first conductor bar 211 is transmitted to the first shielding member 241 via the first transmission member 243 and the first tapered portion 241C. Accordingly, the first shielding member 241 retreats from a shielding position against a biasing force of the first biasing member 242, and the first parallel contact 22 is opened. On the other hand, when the first conductor bar 211 moves to a side separated from the first parallel contact 22 (a right side in the drawing), the first transmission member 243 retreats to the side separated from the first parallel contact 22, so that the first shielding member 241 advances toward a shielding position by the biasing force of the first biasing member 242 to shield the first parallel contact 22.

The second movable contact 31 includes a second conductor bar 311 and a second conductor 312. The second conductor bar 311 is a rod-shaped conductor. The second male contact 311A is provided on one end side in an axial direction of the second conductor bar 311, and the third male contact 311B is provided on the other end side in the axial direction of the second conductor bar 311. The second conductor bar 311 is supported by a support unit (not shown) to be movable along the axial direction of the second conductor bar 311, and is moved in both directions along the axial direction of the second conductor bar 311 by the second driving mechanism 34. The first conductor bar 211 and the second conductor bar 311 are disposed in parallel.

The second conductor 312 is a conductor having flexibility or tensile strength such as an electric wire or a flexible printed wiring board. One end of the second conductor 312 is connected to the third terminal 13, and the other end of the second conductor 312 is connected to a central portion in the axial direction of the second conductor bar 311. The second conductor 312 is deformed or displaced following the movement of the second conductor bar 311 in the axial direction.

The series contact 32 is a female-side contact to which the second male contact 311A of the second conductor bar 311 is fitted, and is integrally formed of a conductive material with the first parallel contact 22 and the fourth terminal 14. On the other hand, the second parallel contact 33 is a female-side contact to which the third male contact 311B of the second conductor bar 311 is fitted. A distance between the series contact 32 and the second parallel contact 33 is longer than a length of the second conductor bar 311. Therefore, in a state where the second male contact 311A is fitted to the series contact 32, the third male contact 311B is separated from the second parallel contact 33. Further, in a state where the third male contact 311B is fitted to the second parallel contact 33, the second male contact 311A is separated from the series contact 32.

The second driving mechanism 34 includes a second motor 341, a second ball screw 342, a second slider 343, a second shielding mechanism 35, and a third shielding mechanism 36. The second ball screw 342 is disposed parallel to the second conductor bar 311 and rotates about an axis by a driving force of the second motor 341. The second ball screw 342 may be formed integrally with an output shaft of the second motor 341, or may be coupled to the output shaft of the second motor 341 via a worm gear. The first ball screw 232 and the second ball screw 342 are disposed in parallel.

The second slider 343 is fixed to a central portion in the axial direction of the second conductor bar 311 and is screwed to a screw portion of the second ball screw 342. Accordingly, a rotational force of the second motor 341 is converted into power in the axial direction of the second conductor bar 311 via the second ball screw 342 and the second slider 343.

When the second ball screw 342 is rotated in one direction by the second motor 341, the second conductor bar 311 moves toward the series contact 32, and the second male contact 311A is fitted to the series contact 32. On the other hand, when the second ball screw 342 is rotated in the other direction by the second motor 341, the second conductor bar 311 moves to a side separated from the series contact 32, and the fitting between the second male contact 311A and the series contact 32 is released. Further, when the second conductor bar 311 moves toward the second parallel contact 33 by the rotation of the second ball screw 342 in the other direction, the third male contact 311B is fitted to the second parallel contact 33.

The second shielding mechanism 35 includes a second shielding member 351, a second biasing member 352, and a second transmission member 353. The second shielding member 351 is an insulator and is provided to be movable between a shielding position for shielding the series contact 32 and an open position for opening the series contact 32. A movement direction of the second shielding member 351 is a direction (the up-down direction in the drawing) orthogonal to the movement direction of the second conductor bar 311.

The second shielding member 351 includes a second shielding portion 351A, a second attachment portion 351B, and a second tapered portion 351C. The second shielding portion 351A is a plate-shaped portion that opens and closes an opening of the series contact 32, and is disposed at a right angle to the axial direction of the second conductor bar 311. The second attachment portion 351B is a flat surface to which the second biasing member 352 is attached. The second tapered portion 351C is an inclined surface with which the second transmission member 353 is in contact. The second attachment portion 351B and the second tapered portion 351C are provided in a trapezoidal block when viewed in the front-rear direction in the drawing, the second attachment portion 351B constitutes a lower side surface of the block in the drawing, and the second tapered portion 351C constitutes a right side inclined surface of the block in the drawing. The second shielding portion 351A extends between the second male contact 311A and the series contact 32 from an upper corner and a left corner in the drawing of the block.

The second biasing member 352 is an elastic member such as a spring. One end of the second biasing member 352 is attached to the second attachment portion 351B, and the other end of the second biasing member 352 is attached to a surface facing the second attachment portion 351B in the up-down direction in the drawing. The second biasing member 352 biases the second shielding member 351 toward the second male contact 311A (an upper side in the drawing).

The second transmission member 353 is a plate-shaped or rod-shaped insulator formed in a T-shape. The second transmission member 353 is divided into a horizontal portion and a vertical portion. The horizontal portion of the second transmission member 353 is parallel to the axial direction of the second conductor bar 311, and the vertical portion of the second transmission member 353 is perpendicular to the axial direction of the second conductor bar 311. A tip (an upper end in the drawing) of the vertical portion of the second transmission member 353 is fixed to a central portion in the axial direction of the second conductor bar 311. On the other hand, one end (a left end in the drawing) of the horizontal portion of the second transmission member 353 in a longitudinal direction is in contact with the second tapered portion 351C of the second shielding member 351. The other end (a right end in the drawing) of the horizontal portion of the second transmission member 353 in the longitudinal direction is in contact with a third tapered portion 361C of a third shielding member 361 to be described later.

The second tapered portion 351C is provided to be inclined from the series contact 32 toward the second transmission member 353 (from the left side in the drawing to the right side in the drawing) from the second shielding portion 351A toward the second attachment portion 351B (from the upper side in the drawing to the lower side in the drawing). The second tapered portion 351C and the second transmission member 353 are pressed against each other by the second biasing member 352. In a state where the second shielding portion 351A shields the opening of the series contact 32, one end of the horizontal portion of the second transmission member 353 in the longitudinal direction is in contact with a lower end of the second tapered portion 351C in the drawing.

The third shielding mechanism 36 includes the third shielding member 361, a third biasing member 362, and the second transmission member 353. The second transmission member 353 is shared by the second shielding mechanism 35 and the third shielding mechanism 36.

The third shielding member 361 is an insulator and is provided to be movable between a shielding position for shielding the second parallel contact 33 and an open position for opening the second parallel contact 33. A movement direction of the third shielding member 361 is a direction (the up-down direction in the drawing) orthogonal to the movement direction of the second conductor bar 311.

The third shielding member 361 includes a third shielding portion 361A, a third attachment portion 361B, and a third tapered portion 361C. The third shielding portion 361A is a plate-shaped portion that opens and closes an opening of the second parallel contact 33, and is disposed at a right angle to the axial direction of the second conductor bar 311. The third attachment portion 361B is a flat surface to which the third biasing member 362 is attached. The third tapered portion 361C is an inclined surface with which the other end of the horizontal portion of the second transmission member 353 in the longitudinal direction is in contact. The third attachment portion 361B and the third tapered portion 361C are provided in a trapezoidal block when viewed in the front-rear direction in the drawing, the third attachment portion 361B constitutes a lower side surface of the block in the drawing, and the third tapered portion 361C constitutes a left side inclined surface of the block in the drawing. The third shielding portion 361A extends between the third male contact 311B and the second parallel contact 33 from an upper corner and a right corner in the drawing of the block.

The third biasing member 362 is an elastic member such as a spring. One end of the third biasing member 362 is attached to the third attachment portion 361B, and the other end of the third biasing member 362 is attached to a surface facing the third attachment portion 361B in the up-down direction in the drawing. The third biasing member 362 biases the third shielding member 361 toward the third male contact 311B (an upper side in the drawing).

The third tapered portion 361C is provided to be inclined from the second parallel contact 33 toward the second transmission member 353 (from the right side in the drawing to the left side in the drawing) from the third shielding portion 361A toward the third attachment portion 361B (from the upper side in the drawing to the lower side in the drawing). The third tapered portion 361C and the second transmission member 353 are pressed against each other by the third biasing member 362. In a state where the third shielding portion 361A shields the opening of the second parallel contact 33, the other end of the horizontal portion of the second transmission member 353 in the longitudinal direction is in contact with a lower end of the third tapered portion 361C in the drawing.

When the second conductor bar 311 moves toward the series contact 32 (a left side in the drawing), the second transmission member 353 moves forward toward the series contact 32, so that the power of the second conductor bar 311 is transmitted to the second shielding member 351 via the second transmission member 353 and the second tapered portion 351C. Accordingly, the second shielding member 351 retreats from a shielding position against a biasing force of the second biasing member 352, and the series contact 32 is opened. On the other hand, when the second conductor bar 311 moves to the side separated from the series contact 32 (a right side in the drawing), the second transmission member 353 retreats to the side separated from the series contact 32, so that the second shielding member 351 advances to the shielding position side by the biasing force of the second biasing member 352 to shield the series contact 32.

On the other hand, when the second conductor bar 311 moves toward the second parallel contact 33 (a right side in the drawing), the second transmission member 353 moves forward toward the second parallel contact 33, so that the power of the second conductor bar 311 is transmitted to the third shielding member 361 via the second transmission member 353 and the third tapered portion 361C. Accordingly, the third shielding member 361 retracts from a shielding position against a biasing force of the third biasing member 362, and the second parallel contact 33 is opened. On the other hand, when the second conductor bar 311 moves to a side separated from the second parallel contact 33 (a left side in the drawing), the second transmission member 353 retreats to the side separated from the second parallel contact 33, so that the third shielding member 361 advances toward the shielding position by the biasing force of the third biasing member 362 to shield the second parallel contact 33.

The connection restriction mechanism 40 includes a rotary member 41, a first biasing member 42, a second biasing member 43, and a shaft 44. The rotary member 41 is a plate member having an isosceles trapezoidal shape when viewed in the front-rear direction in the drawing (a direction orthogonal to a direction in which the first parallel contact 22 and the series contact 32 are arranged and a direction in which the series contact 32 and the second parallel contact 33 are arranged).

The rotary member 41 includes a first tapered surface 41A, a second tapered surface 41B, and a through hole. The through hole is formed at a center of the rotary member 41, and the rotary member 41 is symmetrical with respect to the through hole. The shaft 44 is inserted into the through hole, and the rotary member 41 is rotatably supported by the shaft 44.

The rotary member 41 is attached to the shaft 44 such that the first tapered surface 41A and the second tapered surface 41B face an opposite side (a right side in the drawing) of the first parallel contact 22 and the series contact 32 in a state where the first tapered surface 41A and the second tapered surface 41B are aligned in the up-down direction in the drawing. The first tapered surface 41A is disposed to face a tip (a lower end in the drawing) of the first slider 233 in a movement direction (a left-right direction in the drawing) of the first slider 233. The second tapered surface 41B is disposed to face a tip (an upper end in the drawing) of the second slider 343 in a movement direction (a left-right direction in the drawing) of the second slider 343.

The first biasing member 42 and the second biasing member 43 are torsion coil springs. The first biasing member 42 biases the rotary member 41 in a clockwise direction in the drawing, and the second biasing member 43 biases the rotary member 41 in a counterclockwise direction in the drawing. Here, in a state where the first tapered surface 41A and the second tapered surface 41B are aligned in the up-down direction in the drawing, the first biasing member 42 and the second biasing member 43 are not elastically deformed. That is, the first biasing member 42 and the second biasing member 43 that are not elastically deformed hold the rotary member 41 in a posture in which the first tapered surface 41A and the second tapered surface 41B are aligned in the up-down direction in the drawing.

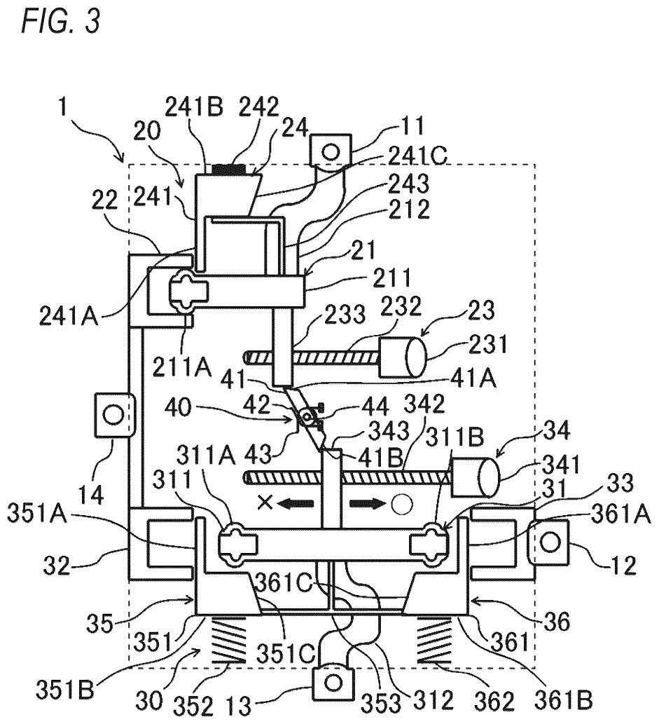

FIGS. 3 to 5 are diagrams showing an operation of the battery switching device 1 shown in FIG. 2. FIG. 3 shows a state where the first movable contact 21 and the first parallel contact 22 of the first contact device 20 are connected and the second movable contact 31 and the series contact 32 and the second parallel contact 33 of the second contact device 30 are disconnected.

As shown in FIG. 3, when the first ball screw 232 is rotated in one direction by the first motor 231, the first conductor bar 211 moves toward the first parallel contact 22, and the first male contact 211A is fitted to the first parallel contact 22. At this time, the first transmission member 243 moves forward toward the first parallel contact 22, so that the power of the first conductor bar 211 is transmitted to the first shielding member 241 via the first transmission member 243 and the first tapered portion 241C. Accordingly, the first shielding member 241 retreats from a shielding position against the biasing force of the first biasing member 242, and the first parallel contact 22 is opened.

Here, when the first conductor bar 211 moves toward the first parallel contact 22, the power of the first conductor bar 211 is transmitted to the rotary member 41 via a tip of the first slider 233 and the first tapered surface 41A. Accordingly, the rotary member 41 rotates in the counterclockwise direction in the drawing against the biasing force of the first biasing member 42, and the second tapered surface 41B is brought into contact with the tip of the second slider 343. In this state, the movement of the second slider 343 toward the series contact 32 is prevented by the interference between the second slider 343 and the rotary member 41. That is, in a state where the first conductor bar 211 is fitted to the first parallel contact 22, the movement of the second conductor bar 311 toward the series contact 32 is prevented by the connection restriction mechanism 40. Therefore, the connection between the first movable contact 21 and the first parallel contact 22 of the first contact device 20 and the connection between the second movable contact 31 and the series contact 32 of the second contact device 30 are prevented from occurring simultaneously.

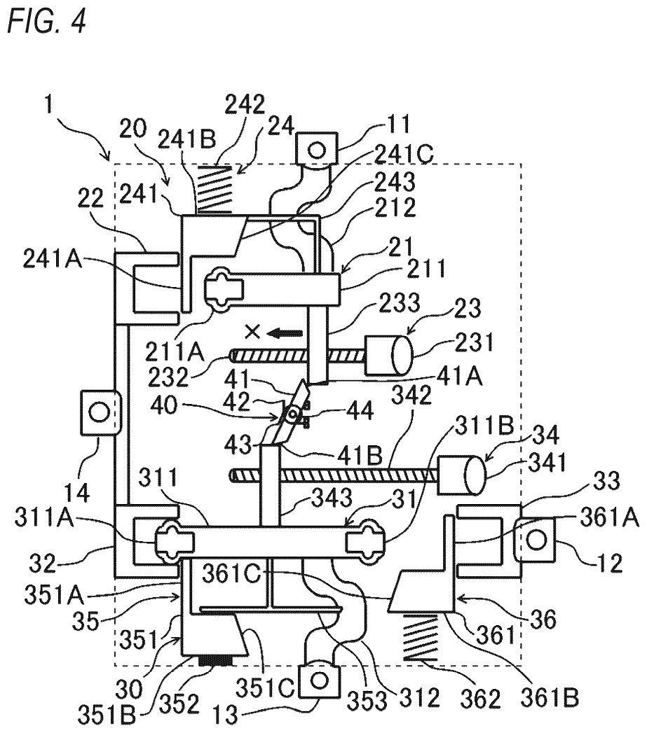

FIG. 4 shows a state where the second movable contact 31 and the series contact 32 of the second contact device 30 are connected and the first movable contact 21 and the first parallel contact 22 of the first contact device 20 are disconnected. As shown in this drawing, when the second ball screw 342 is rotated in one direction by the second motor 341, the second conductor bar 311 moves toward the series contact 32, and the second male contact 311A is fitted to the series contact 32. At this time, the second conductor bar 311 moves forward toward the series contact 32, so that the power of the second conductor bar 311 is transmitted to the second shielding member 351 via the second transmission member 353 and the second tapered portion 351C. Accordingly, the second shielding member 351 retreats from a shielding position against the biasing force of the second biasing member 352, and the series contact 32 is opened.

Here, when the second conductor bar 311 moves toward the series contact 32, the power of the second conductor bar 311 is transmitted to the rotary member 41 via the tip of the second slider 343 and the second tapered surface 41B. Accordingly, the rotary member 41 rotates in the clockwise direction in the drawing against the biasing force of the second biasing member 43, and the first tapered surface 41A is brought into contact with the tip of the first slider 233. In this state, the movement of the first slider 233 toward the first parallel contact 22 is prevented by the interference between the first slider 233 and the rotary member 41. That is, in a state where the second conductor bar 311 is fitted to the series contact 32, the movement of the first conductor bar 211 toward the first parallel contact 22 is prevented by the connection restriction mechanism 40. Therefore, the connection between the second movable contact 31 and the series contact 32 of the second contact device 30 and the connection between the first movable contact 21 and the first parallel contact 22 of the first contact device 20 are prevented from occurring simultaneously.

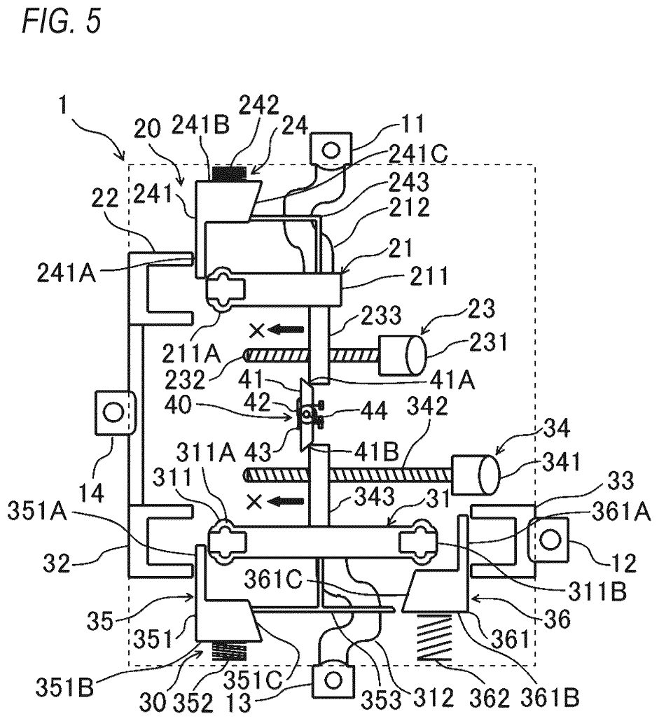

FIG. 5 shows a state where the first conductor bar 211 of the first contact device 20 and the second conductor bar 311 of the second contact device 30 are simultaneously moved toward the first parallel contact 22 and the series contact 32. In the state shown in this drawing, the tip of the first slider 233 is in contact with the first tapered surface 41A of the rotary member 41, and the tip of the second slider 343 is in contact with the second tapered surface 41B of the rotary member 41. At this time, rotation of the rotary member 41 in the clockwise direction in the drawing is prevented by interference between the first slider 233 and the first tapered surface 41A, and rotation of the rotary member 41 in the counterclockwise direction in the drawing is prevented by interference between the second slider 343 and the second tapered surface 41B. That is, the connection restriction mechanism 40 prevents the first conductor bar 211 and the second conductor bar 311 from approaching the first parallel contact 22 and the series contact 32 simultaneously. Therefore, the connection between the first movable contact 21 and the first parallel contact 22 of the first contact device 20 and the connection between the second movable contact 31 and the series contact 32 of the second contact device 30 are prevented from occurring simultaneously.

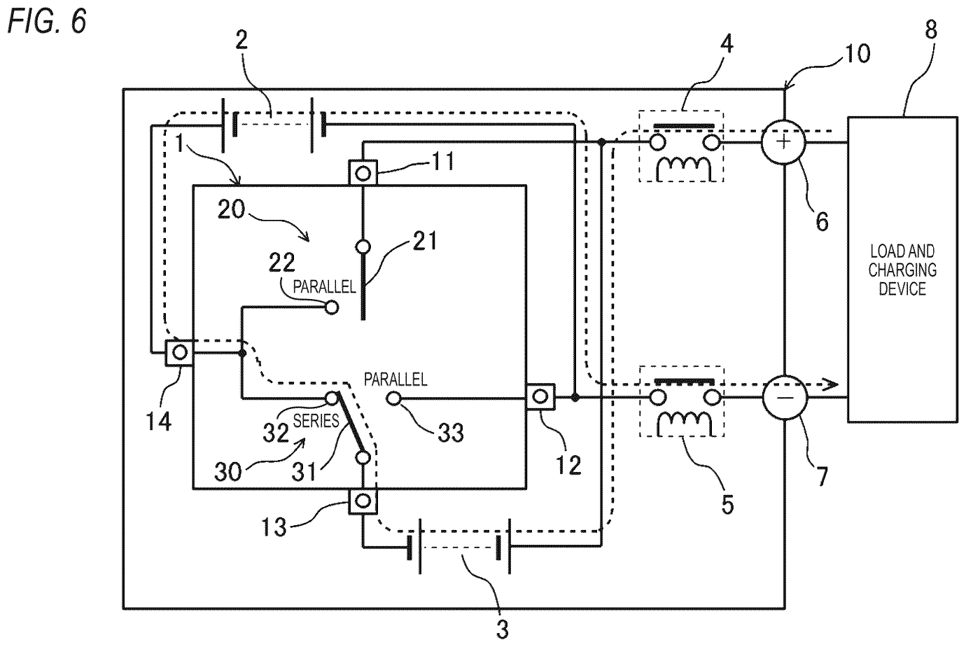

FIGS. 6 to 9 are diagrams showing an operation of the battery system 10 shown in FIG. 1. FIG. 6 shows a state where the first movable contact 21 and the first parallel contact 22 of the first contact device 20 are disconnected and the second movable contact 31 and the series contact 32 of the second contact device 30 are connected. In the state shown in this drawing, the first battery module 2 and the second battery module 3 are connected in series. In this state, the connection between the first movable contact 21 and the first parallel contact 22 of the first contact device 20 is prevented by the connection restriction mechanism 40 shown in FIG. 2 and the like.

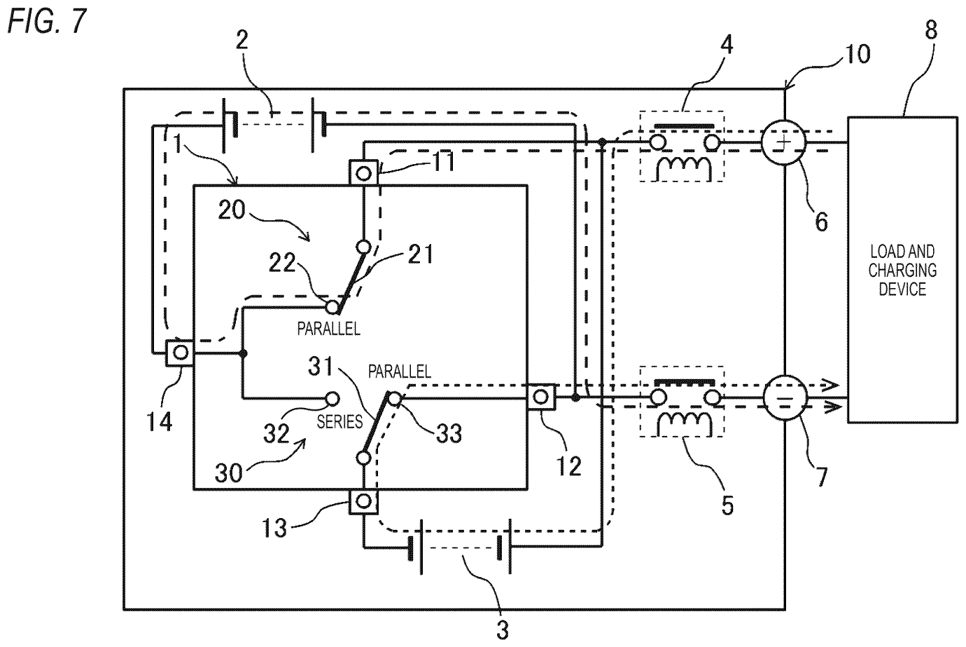

FIG. 7 shows a state where the first movable contact 21 and the first parallel contact 22 of the first contact device 20 are connected and the second movable contact 31 and the second parallel contact 33 of the second contact device 30 are connected. In the state shown in this drawing, the first battery module 2 and the second battery module 3 are connected in parallel. In this state, the connection between the second movable contact 31 and the series contact 32 of the second contact device 30 is prevented by the connection restriction mechanism 40.

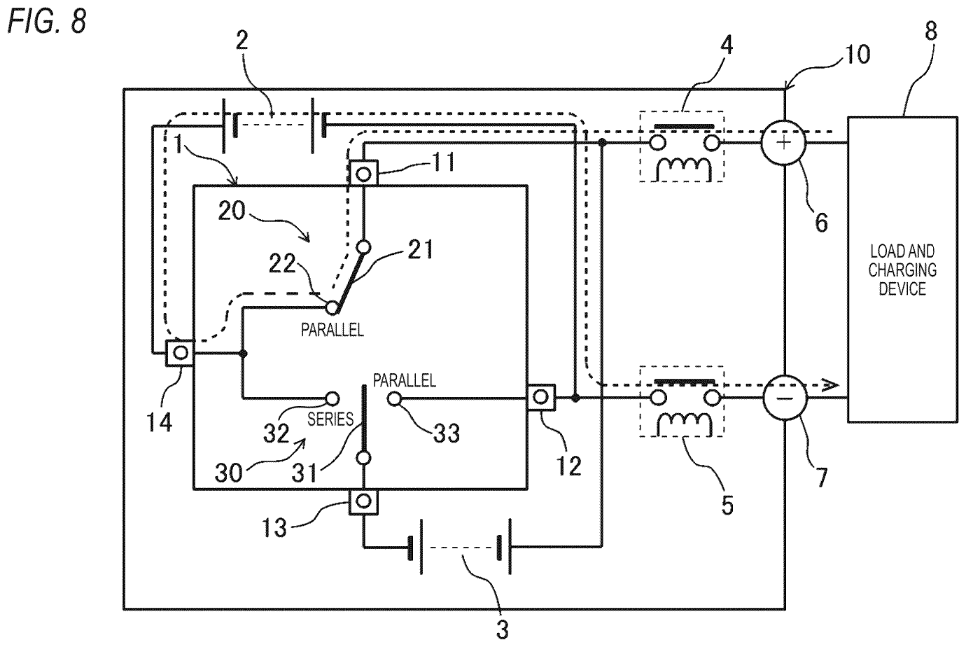

FIG. 8 shows a state where the first movable contact 21 and the first parallel contact 22 of the first contact device 20 are connected and the second movable contact 31 and the series contact 32 and the second parallel contact 33 of the second contact device 30 are disconnected. In the state shown in this drawing, the first battery module 2 is connected to the load and charging device 8, and the second battery module 3 is disconnected from the load and charging device 8. In this state, the connection between the second movable contact 31 and the series contact 32 of the second contact device 30 is prevented by the connection restriction mechanism 40.

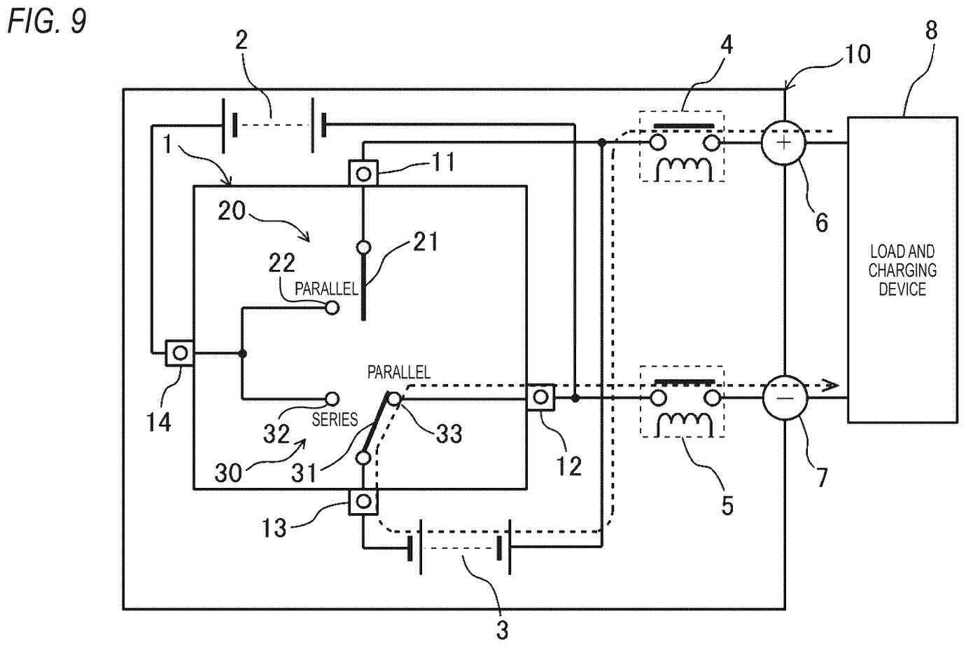

FIG. 9 shows a state where the first movable contact 21 and the first parallel contact 22 of the first contact device 20 are disconnected and the second movable contact 31 and the second parallel contact 33 of the second contact device 30 are connected. In the state shown in the figure, the second battery module 3 is connected to the load and charging device 8, and the first battery module 2 is disconnected from the load and charging device 8. In this state, the connection between the first movable contact 21 and the first parallel contact 22 of the first contact device 20 is not prevented by the connection restriction mechanism 40.

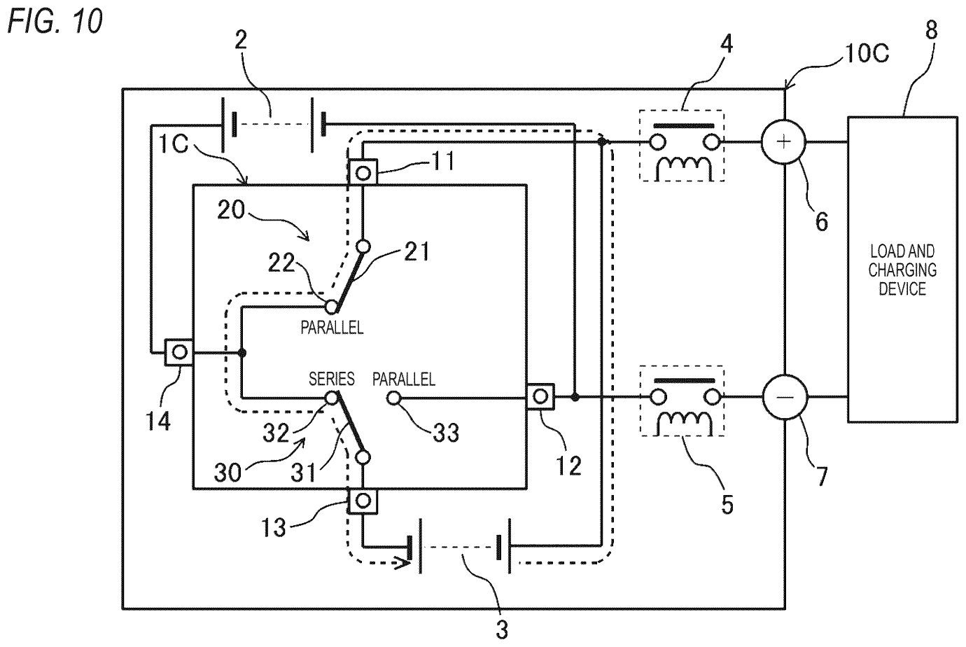

FIG. 10 shows an operation of a battery system 10C according to a comparative example. In the battery system 10C shown in the drawing, similarly to the battery system 10 according to the above-described embodiment, the first conductor bar 211 and the second conductor bar 311 linearly move along the axial direction, so that the first battery module 2 and the second battery module 3 are connected in series or in parallel.

Here, a battery switching device 1C of the battery system 10C is different from the battery switching device 1 according to the above-described embodiment in that the battery switching device 1C does not include the connection restriction mechanism 40. Therefore, when the first male contact 211A approaches the first parallel contact 22, the second male contact 311A cannot be prevented from approaching the series contact 32. Further, when the second male contact 311A approaches the series contact 32, the first male contact 211A cannot be prevented from approaching the first parallel contact 22. Therefore, in the battery switching device 1C, the connection between the first movable contact 21 and the first parallel contact 22 of the first contact device 20 and the connection between the second movable contact 31 and the series contact 32 of the second contact device 30 occur simultaneously, and the first battery module 2 or the second battery module 3 cannot be prevented from being short-circuited.

On the other hand, in the battery switching device 1 according to the present embodiment, the connection restriction mechanism 40 prevents the second male contact 311A from being connected to the series contact 32 in a state where the first male contact 211A is connected to the first parallel contact 22. Further, the connection restriction mechanism 40 prevents the first male contact 211A from being connected to the first parallel contact 22 in a state where the second male contact 311A is connected to the series contact 32. Therefore, according to the battery switching device 1 according to the present embodiment, the connection between the first movable contact 21 and the first parallel contact 22 of the first contact device 20 and the connection between the second movable contact 31 and the series contact 32 of the second contact device 30 occur simultaneously, the first battery module 2 or the second battery module 3 can be prevented from being short-circuited, and safety can be improved.

The battery switching device 1 according to the present embodiment includes the first driving mechanism 23 that linearly moves the first conductor bar 211 in a first direction and a second direction opposite to the first direction along the axial direction. The first driving mechanism 23 includes the first slider 233 fixed to the first conductor bar 211, the first ball screw 232 screwed with the first slider 233, and the first motor 231 that rotates the first ball screw 232, and is not deformed even when an external force is applied. Therefore, the first contact device 20 that is not affected by an external force can be configured, the first movable contact 21 and the first parallel contact 22 can be prevented from coming into contact with each other due to the external force, and the first battery module 2 or the second battery module 3 can be prevented from being short-circuited due to the external force.

In addition, when the energization of the first motor 231 is stopped, the first conductor bar 211 can be locked at a position at a point when the energization is stopped. Accordingly, when the energization of the first motor 231 is stopped, it is possible to maintain the connection state between the first male contact 211A and the first parallel contact 22 or maintain the disconnection state between the first male contact 211A and the first parallel contact 22. Therefore, energization for maintaining the connection state between the first male contact 211A and the first parallel contact 22 or maintaining the disconnection state between the first male contact 211A and the first parallel contact 22 is unnecessary, and power consumption can be reduced.

Further, when the first conductor bar 211 is linearly moved in the second direction by the first driving mechanism 23, the first male contact 211A and the first parallel contact 22 as a female contact are disconnected. Accordingly, an operation failure of the switching to the first contact device 20 caused by the fixation of the first movable contact 21 can be reduced, and the safety of the battery switching device 1 can be improved.

The battery switching device 1 according to the present embodiment includes the second driving mechanism 34 that linearly moves the second conductor bar 311 in the first direction and the second direction along the axial direction. The second driving mechanism 34 includes the second slider 343 fixed to the second conductor bar 311, the second ball screw 342 screwed with the second slider 343, and the second motor 341 that rotates the second ball screw 342, and is not deformed even when an external force is applied. Therefore, the second contact device 30 that is not affected by an external force can be configured, the second movable contact 31 and the series contact 32 can be prevented from coming into contact with each other due to the external force, and the first battery module 2 or the second battery module 3 can be prevented from being short-circuited due to the external force.

In addition, when the energization of the second motor 341 is stopped, the second conductor bar 311 can be locked at a position at a point when the energization is stopped. Accordingly, when the energization of the second motor 341 is stopped, it is possible to maintain the connection state or the disconnection state between the second male contact 311A and the series contact 32 or maintain the connection state or the disconnection state between the third male contact 311B and the second parallel contact 33. Therefore, energization for maintaining the connection state or the disconnection state between the second male contact 311A and the series contact 32 or maintaining the connection state or the disconnection state between the third male contact 311B and the second parallel contact 33 is unnecessary, and power consumption can be reduced.

Further, when the second conductor bar 311 is linearly moved in the second direction by the second driving mechanism 34, the second male contact 311A and the series contact 32 as a female contact are disconnected. The second conductor bar 311 is linearly moved in the first direction by the second driving mechanism 34, so that the third male contact 311B and the second parallel contact 33 as the female contact are disconnected. Accordingly, an operation failure of the switching to the second contact device 30 caused by the fixation of the second movable contact 31 can be reduced, and the safety of the battery switching device 1 can be improved.

In the battery switching device 1 according to the present embodiment, the connection restriction mechanism 40 includes the rotary member 41 that is rotatably provided. The rotary member 41 is rotated to a position where the movement of the second slider 343 in the first direction is prevented by the movement of the first slider 233 in the first direction. Further, the rotary member 41 is rotated to a position where the movement of the first slider 233 in the first direction is prevented by the movement of the second slider 343 in the first direction. Therefore, the first conductor bar 211 and the second conductor bar 311 can be prevented from moving in the first direction simultaneously, and the connection between the first male contact 211A and the first parallel contact 22 and the connection between the second male contact 311A and the series contact 32 can be prevented from occurring simultaneously.

In the battery switching device 1 according to the present embodiment, the insulating first shielding member 241 is disposed to be movable between a first shielding position for shielding the first parallel contact 22 and a first open position for opening the first parallel contact 22. Further, the insulating second shielding member 351 is disposed to be movable between a second shielding position for shielding the series contact 32 and a second open position for opening the series contact 32. Further, the insulating third shielding member 361 is disposed to be movable between a third shielding position for shielding the second parallel contact 33 and a third open position for opening the second parallel contact 33.

The first shielding mechanism 24 moves the first shielding member 241 from the first shielding position to the first open position in conjunction with movement of the first conductor bar 211 in a direction in which the first conductor bar 211 approaches the first parallel contact 22, and moves the first shielding member 241 from the first open position to the first shielding position in conjunction with movement of the first conductor bar 211 in a direction in which the first conductor bar 211 is separated from the first parallel contact 22. The second shielding mechanism 35 moves the second shielding member 351 from the second shielding position to the second open position in conjunction with movement of the second conductor bar 311 in a direction in which the second conductor bar 311 approaches the series contact 32, and moves the second shielding member 351 from the second open position to the second shielding position in conjunction with movement of the second conductor bar 311 in a direction in which the second conductor bar 311 is separated from the series contact 32. Further, the third shielding mechanism 36 moves the third shielding member 361 from the third shielding position to the third open position in conjunction with movement of the second conductor bar 311 in a direction in which the second conductor bar 311 approaches the second parallel contact 33, and moves the third shielding member 361 from the third open position to the third shielding position in conjunction with movement of the second conductor bar 311 in a direction in which the second conductor bar 311 is separated from the second parallel contact 33.

Accordingly, when the connection between the first conductor bar 211 and the first parallel contact 22 is released, it is possible to prevent the first conductor bar 211 and the first parallel contact 22 from being unintentionally connected by the external force applied to the first contact device 20. Further, when the connection between the second conductor bar 311 and the series contact 32 is released, it is possible to prevent the second conductor bar 311 and the series contact 32 from being unintentionally connected by the external force applied to the second contact device 30. Further, when the connection between the second conductor bar 311 and the second parallel contact 33 is released, it is possible to prevent the second conductor bar 311 and the second parallel contact 33 from being unintentionally connected by the external force applied to the second contact device 30.

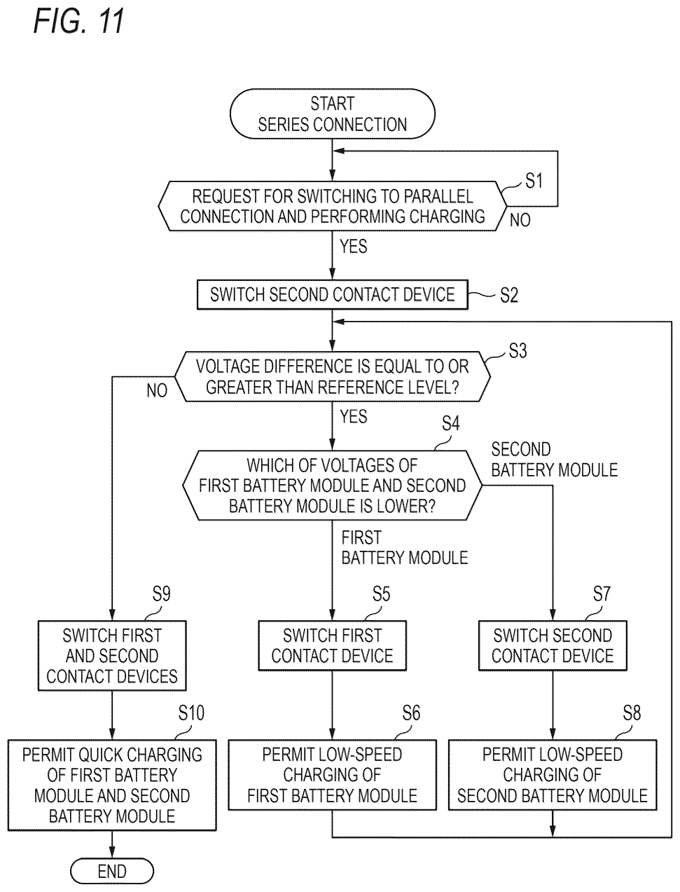

FIG. 11 is a flowchart illustrating a process performed when connection state between the first battery module 2 and the second battery module 3 is switched from series connection to parallel connection before the start of charging of the first battery module 2 and the second battery module 3. The process shown in this flowchart is performed before the electric vehicle stops in a state where the connection state between the first battery module 2 and the second battery module 3 is the series connection state and the charging begins.

First, the control device 50 determines whether a request for switching the connection state between the first battery module 2 and the second battery module 3 from the series connection to the parallel connection and performing charging has been received (step S1). If the determination is yes in step S1, the process proceeds to step S2, and if the determination is no in step S1, step S1 is repeated.

Next, the control device 50 drives the second motor 341 of the second contact device 30 to release the connection between the second movable contact 31 and the series contact 32, and causes the second movable contact 31 to be disconnected from the series contact 32 and the second parallel contact 33 (step S2).

Next, the control device 50 determines whether a voltage difference between the first battery module 2 and the second battery module 3 is equal to or greater than a reference level (step S3). If the determination is yes in step S3, the process proceeds to step S4, and if the determination is no in step S3, the process proceeds to step S9.

When the voltage difference between the first battery module 2 and the second battery module 3 is equal to or greater than the reference level, the control device 50 determines which of the voltages of the first battery module 2 and the second battery module 3 is lower (step S4). When it is determined in step S4 that the voltage of the first battery module 2 is lower, the process proceeds to step S5, and when it is determined in step S4 that the voltage of the second battery module 3 is lower, the process proceeds to step S7.

When the voltage of the first battery module 2 is lower than the voltage of the second battery module 3, the control device 50 drives the first motor 231 of the first contact device 20 to connect the first movable contact 21 and the first parallel contact 22 (step S5). Next, the control device 50 outputs, to the control device on the electric vehicle side, a signal for permitting low-speed charging of the first battery module 2 (step S6). The process proceeds from step S6 to step S3.

When the voltage of the second battery module 3 is lower than the voltage of the first battery module 2, the control device 50 drives the second motor 341 of the second contact device 30 to connect the second movable contact 31 and the second parallel contact 33 (step S7). Next, the control device 50 outputs, to the control device on the electric vehicle side, a signal for permitting low-speed charging of the second battery module 3 (step S8). The process proceeds from step S8 to step S3.

When the voltage difference between the first battery module 2 and the second battery module 3 is less than the reference level, the control device 50 drives the first motor 231 of the first contact device 20 and the second motor 341 of the second contact device 30 to connect the first movable contact 21 and the first parallel contact 22 and connect the second movable contact 31 and the second parallel contact 33 (step S9). Next, the control device 50 outputs, to the control device on the electric vehicle side, a signal for permitting quick charging of the first battery module 2 and the second battery module 3 (step S10).

As described above, in the process shown in FIG. 11, when the voltage difference between the first battery module 2 and the second battery module 3 is less than the reference level, the control device 50 connects the first battery module 2 and the second battery module 3 in parallel and permits quick charging. On the other hand, when the voltage difference between the first battery module 2 and the second battery module 3 is equal to or greater than the reference level, the control device 50 permits low-speed charging of a battery module (the first battery module 2 or the second battery module 3) having an excessively small voltage. Accordingly, when the connection state of the first battery module 2 and the second battery module 3 is switched from the series connection to the parallel connection, a rush current due to the voltage difference between the first battery module 2 and the second battery module 3 can be reduced.

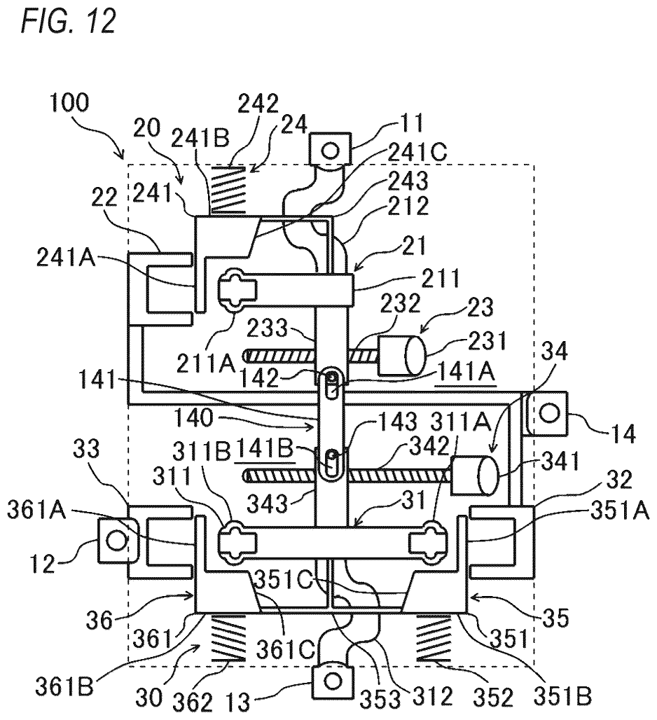

FIG. 12 is a diagram showing a battery switching device 100 according to another embodiment of the present disclosure. The battery switching device 100 shown in the drawing includes a connection restriction mechanism 140. The same components as those of the above-described embodiment are denoted by the same reference numerals, and the description of the above-described embodiment is incorporated.

In the battery switching device 100, the first parallel contact 22 and the second parallel contact 33 are arranged in the up-down direction in the drawing, and the second parallel contact 33 and the series contact 32 are disposed to face each other in the left-right direction in the drawing. The first parallel contact 22, the series contact 32, and the fourth terminal 14 are integrally formed of a conductive material.

The connection restriction mechanism 140 includes a link 141, a first shaft portion 142, and a second shaft portion 143. The link 141 is a plate member in which a first long hole 141A and a second long hole 141B are formed on one end side and the other end side in the longitudinal direction, respectively.

The first shaft portion 142 is provided on a tip side (a lower side in the drawing) of the first slider 233, and is slidably inserted into the first long hole 141A. The second shaft portion 143 is provided on a tip side (an upper side in the drawing) of the second slider 343, and is slidably inserted into the second long hole 141B. The first shaft portion 142 and the second shaft portion 143 are parallel to each other and are disposed to extend along the front-rear direction in the drawing (a direction orthogonal to a direction in which the first parallel contact 22 and the second parallel contact 33 are arranged and a direction in which the second parallel contact 33 and the series contact 32 are arranged).

In a state where the first slider 233, the second slider 343, and the link 141 are aligned on the same straight line, the first shaft portion 142 is in contact with an upper side arc portion of the first long hole 141A, and the second shaft portion 143 is in contact with an upper side arc portion of the second long hole 141B.

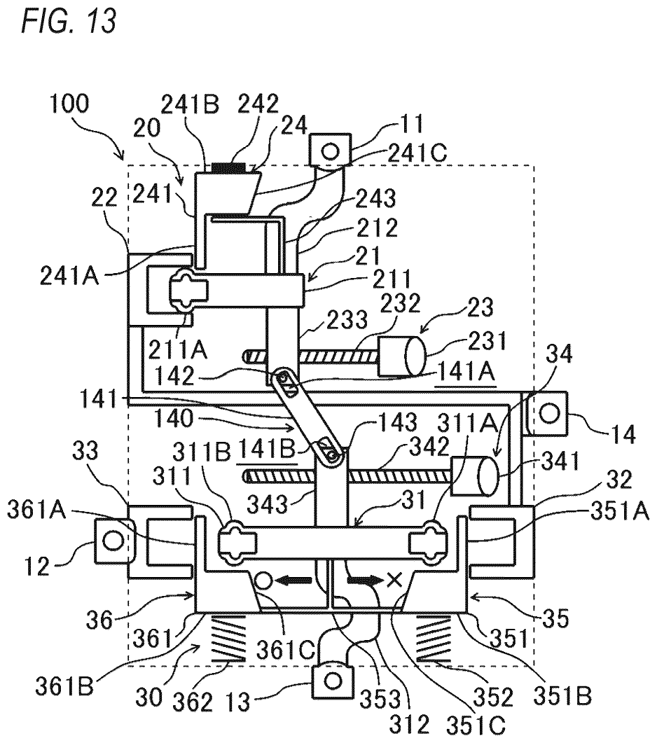

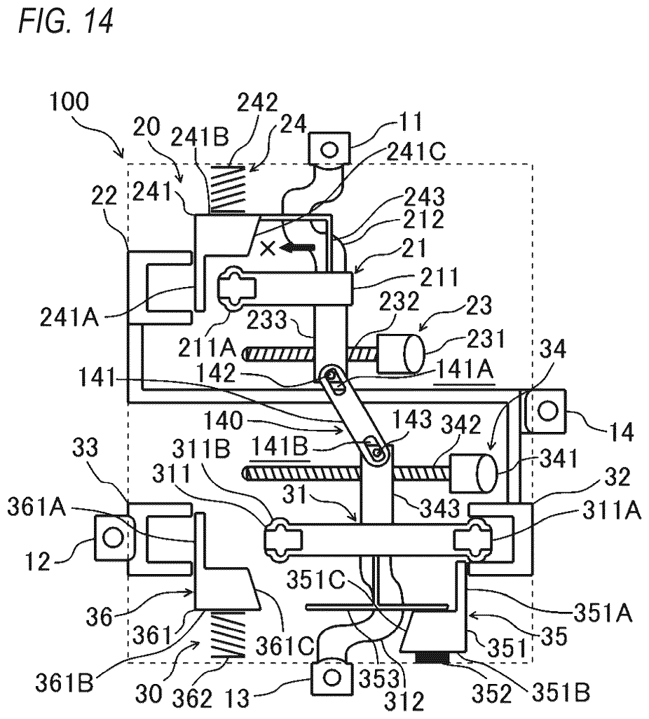

FIGS. 13 and 14 are diagrams showing an operation of the battery switching device 100 shown in FIG. 12. FIG. 13 shows a state where the first movable contact 21 and the first parallel contact 22 of the first contact device 20 are connected and the second movable contact 31 and the series contact 32 and the second parallel contact 33 of the second contact device 30 are disconnected.

As shown in FIG. 13, when the first conductor bar 211 moves toward the first parallel contact 22, the power of the first conductor bar 211 is transmitted to the link 141 via the tip of the first slider 233, the first shaft portion 142, and the first long hole 141A. Accordingly, the link 141 rotates in the counterclockwise direction in the drawing, and a lower side arc portion of the second long hole 141B is pressed against the second shaft portion 143. In this state, the movement of the second slider 343 toward the series contact 32 is prevented by the interference between the second long hole 141B of the link 141 and the second shaft portion 143. That is, in a state where the first conductor bar 211 is fitted to the first parallel contact 22, the movement of the second conductor bar 311 toward the series contact 32 is prevented by the connection restriction mechanism 140. Therefore, the connection between the first movable contact 21 and the first parallel contact 22 of the first contact device 20 and the connection between the second movable contact 31 and the series contact 32 of the second contact device 30 are prevented from occurring simultaneously.

FIG. 14 shows a state where the second movable contact 31 and the series contact 32 of the second contact device 30 are connected and the first movable contact 21 and the first parallel contact 22 of the first contact device 20 are disconnected. As shown in the drawing, when the second conductor bar 311 moves toward the series contact 32, the power of the second conductor bar 311 is transmitted to the link 141 via the tip of the second slider 343, the second shaft portion 143, and the second long hole 141B. Accordingly, the link 141 rotates in the counterclockwise direction in the drawing, and the upper side arc portion of the first long hole 141A is pressed against the first shaft portion 142. In this state, the movement of the first slider 233 toward the first parallel contact 22 is prevented by the interference between the first long hole 141A of the link 141 and the first shaft portion 142. That is, in a state where the second conductor bar 311 is fitted to the series contact 32, the movement of the first conductor bar 211 toward the first parallel contact 22 is prevented by the connection restriction mechanism 140. Therefore, the connection between the second movable contact 31 and the series contact 32 of the second contact device 30 and the connection between the first movable contact 21 and the first parallel contact 22 of the first contact device 20 are prevented from occurring simultaneously.

As described above, in the battery switching device 100 according to the present embodiment, by the movement of the first slider 233 in the second direction opposite to the first direction, the first male contact 211A is connected to the first parallel contact 22 by the movement of the first slider 233 in the first direction, and the first male contact 211A is separated from the first parallel contact 22. Further, by the movement of the second slider 343 in the first direction, the third male contact 311B is connected to the second parallel contact 33, and the second male contact 311A is separated from the series contact 32. Further, by the movement of the second slider 343 in the second direction, the second male contact 311A is connected to the series contact 32, and the third male contact 311B is separated from the second parallel contact 33.

Here, the connection restriction mechanism 140 includes the first shaft portion 142 fixed to the first slider 233, the second shaft portion 143 fixed to the second slider 343, and the link 141. The link 141 has the first long hole 141A through which the first shaft portion 142 is slidably inserted and the second long hole 141B through which the second shaft portion 143 is slidably inserted.

Accordingly, in the state where the first male contact 211A is connected to the first parallel contact 22, the movement of the second conductor bar 311 in a direction (the second direction) in which the second male contact 311A approaches the series contact 32 is prevented by the link 141, the first shaft portion 142, and the second shaft portion 143. In the state where the second male contact 311A is connected to the series contact 32, the movement of the first conductor bar 211 in a direction (the first direction) in which the first male contact 211A approaches the first parallel contact 22 is prevented by the link 141, the first shaft portion 142, and the second shaft portion 143. Therefore, according to the battery switching device 100 according to the present embodiment, the connection between the first movable contact 21 and the first parallel contact 22 of the first contact device 20 and the connection between the second movable contact 31 and the series contact 32 of the second contact device 30 occur simultaneously, the first battery module 2 or the second battery module 3 can be prevented from being short-circuited, and safety can be improved.

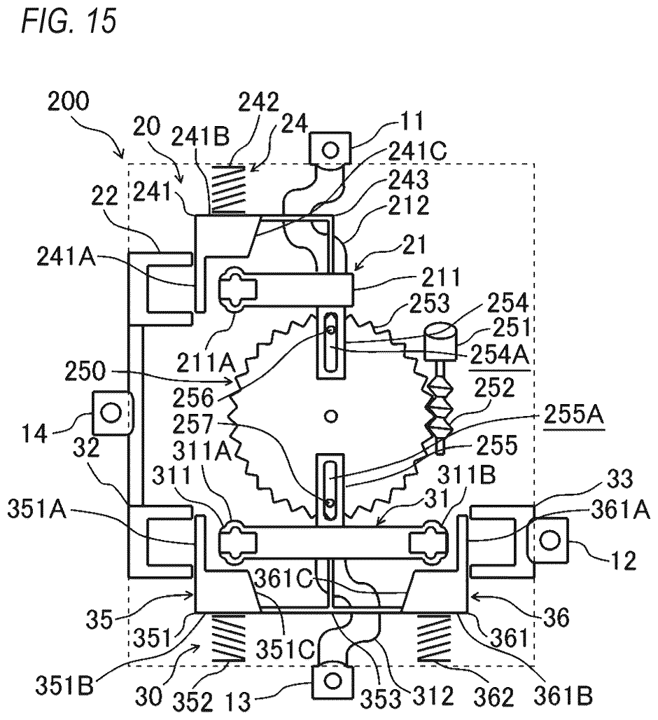

FIG. 15 is a diagram showing a battery switching device 200 according to another embodiment of the present disclosure. The battery switching device 200 shown in the drawing includes a drive and connection restriction mechanism 250. The drive and connection restriction mechanism 250 has functions equivalent to those of the first driving mechanism 23, the second driving mechanism 34, and the connection restriction mechanism 40 of the battery switching device 1 shown in FIG. 2 and the like. The same components as those of the above-described embodiment are denoted by the same reference numerals, and the description of the above-described embodiment is incorporated.

In the battery switching device 200, similarly to the above-described battery switching device 1, the first parallel contact 22 and the series contact 32 are arranged in the up-down direction in the drawing, and the series contact 32 and the second parallel contact 33 are arranged in the left-right direction in the drawing. The first parallel contact 22, the series contact 32, and the fourth terminal 14 are integrally formed of a conductive material.

The drive and connection restriction mechanism 250 includes a motor 251, a worm 252, a worm wheel 253, a first transmission member 254, a second transmission member 255, a first shaft portion 256, and a second shaft portion 257. An output shaft of the motor 251 and the worm 252 are integrated. The output shaft of the motor 251 and the worm 252 extend along a vertical direction (the up-down direction in the drawing). A rotary shaft of the worm wheel 253 is disposed along the front-rear direction in the drawing (a direction orthogonal to the movement direction of the first conductor bar 211 and the second conductor bar 311 and the output shaft of the motor 251). The worm 252 and the worm wheel 253 mesh with each other, and when the motor 251 is driven, the worm 252 and the worm wheel 253 rotate.

The first transmission member 254 is a plate member in which a first long hole 254A is formed along the up-down direction in the drawing (a direction parallel to the output shaft of the motor 251), and is fixed to the other end side in the axial direction of the first conductor bar 211. The second transmission member 255 is a plate member in which a second long hole 255A is formed along the up-down direction in the drawing, and is fixed to the central portion in the axial direction of the second conductor bar 311.

The first shaft portion 256 and the second shaft portion 257 are fixed to one surface of the worm wheel 253. The first shaft portion 256 and the second shaft portion 257 are disposed symmetrically with respect to the rotary shaft of the worm wheel 253. The first shaft portion 256 is slidably inserted into the first long hole 254A, and the second shaft portion 257 is slidably inserted into the second long hole 255A.

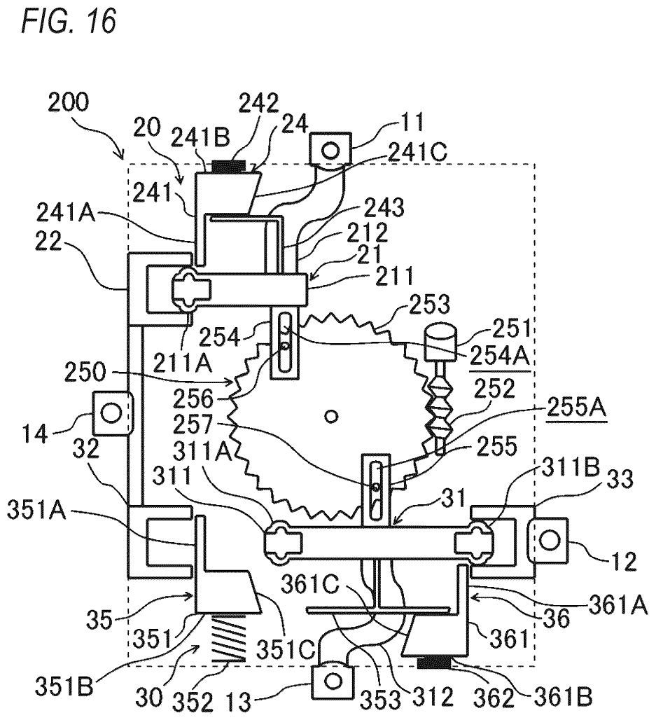

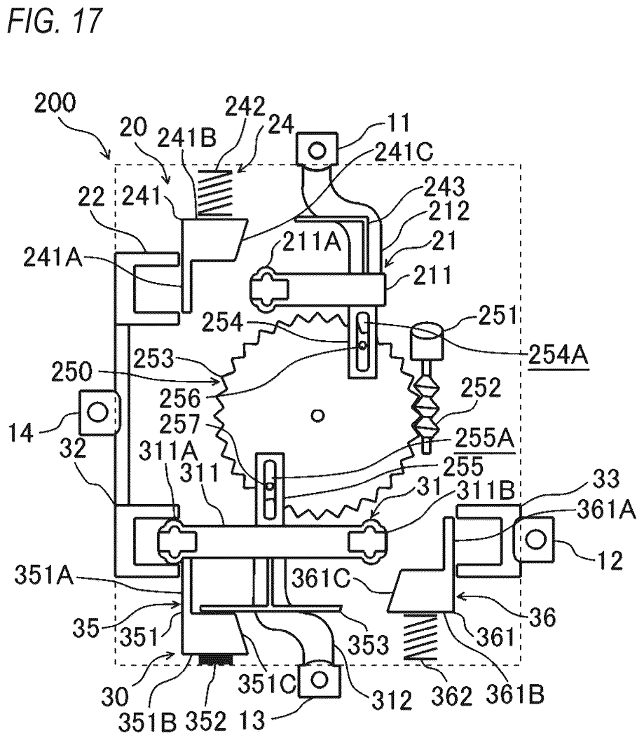

FIGS. 16 and 17 are diagrams showing an operation of the battery switching device 200 shown in FIG. 15. FIG. 16 shows a state where the first movable contact 21 and the first parallel contact 22 of the first contact device 20 are connected and the second movable contact 31 and the second parallel contact 33 of the second contact device 30 are connected.

As shown in FIG. 16, when the worm 252 is rotated in one direction by the motor 251, the worm wheel 253 rotates in the counterclockwise direction in the drawing, a rotational force of the worm wheel 253 is transmitted to the first transmission member 254 via the first shaft portion 256 and the first long hole 254A, and the first conductor bar 211 moves toward the first parallel contact 22. At this time, the rotational force of the worm wheel 253 is transmitted to the second transmission member 255 via the second shaft portion 257 and the second long hole 255A, and the second conductor bar 311 moves toward the second parallel contact 33. That is, when the first conductor bar 211 moves toward the first parallel contact 22, the second conductor bar 311 moves toward the second parallel contact 33. Therefore, the connection between the first movable contact 21 and the first parallel contact 22 of the first contact device 20 and the connection between the second movable contact 31 and the series contact 32 of the second contact device 30 are prevented from occurring simultaneously.

FIG. 17 shows a state where the second movable contact 31 and the series contact 32 of the second contact device 30 are connected and the first movable contact 21 and the first parallel contact 22 of the first contact device 20 are disconnected. As shown in the drawing, when the worm 252 is rotated in the other direction by the motor 251, the worm wheel 253 rotates in the clockwise direction in the drawing, the rotational force of the worm wheel 253 is transmitted to the second transmission member 255 via the second shaft portion 257 and the second long hole 255A, and the second conductor bar 311 moves toward the series contact 32. At this time, the rotational force of the worm wheel 253 is transmitted to the first transmission member 254 via the first shaft portion 256 and the first long hole 254A, and the first conductor bar 211 moves toward a side separated from the first parallel contact 22. That is, when the second conductor bar 311 moves toward the series contact 32, the first conductor bar 211 moves toward the side separated from the first parallel contact 22. Therefore, the connection between the first movable contact 21 and the first parallel contact 22 of the first contact device 20 and the connection between the second movable contact 31 and the series contact 32 of the second contact device 30 are prevented from occurring simultaneously.

As described above, in the battery switching device 200 according to the present embodiment, the drive and connection restriction mechanism 250 includes the worm wheel 253, the worm 252 that meshes with the worm wheel 253, and the motor 251 that rotates the worm 252. The drive and connection restriction mechanism 250 includes the first shaft portion 256 and the second shaft portion 257 that are disposed symmetrically with respect to the rotary shaft of the worm wheel 253 and fixed to the worm wheel 253, a first transmission member 254 that is fixed to the first conductor bar 211, and the second transmission member 255 that is fixed to the second conductor bar 311. The first transmission member 254 has the first long hole 254A into which the first shaft portion 256 is slidably inserted, and the second transmission member 255 has the second long hole 255A into which the second shaft portion 257 is slidably inserted.

In the battery switching device 200 according to the present embodiment, the first conductor bar 211 is moved in the first direction and the first male contact 211A is connected to the first parallel contact 22 by rotation of the worm wheel 253 in a first rotation direction. At this time, the second conductor bar 311 is moved in the second direction opposite to the first direction, the third male contact 311B is connected to the second parallel contact 33, and the second male contact 311A is separated from the series contact 32. On the other hand, the first conductor bar 211 is moved in the second direction and the first male contact 211A is separated from the first parallel contact 22 by rotation of the worm wheel 253 in a second rotation direction opposite to the first rotation direction. At this time, the second conductor bar 311 is moved in the first direction, the second male contact 311A is connected to the series contact 32, and the third male contact 311B is separated from the second parallel contact 33.

Accordingly, when the first male contact 211A of the first conductor bar 211 is moved in the direction in which the first male contact 211A approaches the first parallel contact 22, the second conductor bar 311 is prevented from moving in the direction in which the second male contact 311A approaches the series contact 32. Further, when the second male contact 311A of the second conductor bar 311 is moved in the direction in which the second male contact 311A approaches the series contact 32, the first conductor bar 211 is prevented from moving in the direction in which the first male contact 211A approaches the first parallel contact 22. Therefore, according to the battery switching device 200 according to the present embodiment, the connection between the first movable contact 21 and the first parallel contact 22 of the first contact device 20 and the connection between the second movable contact 31 and the series contact 32 of the second contact device 30 occur simultaneously, the first battery module 2 or the second battery module 3 can be prevented from being short-circuited, and safety can be improved.

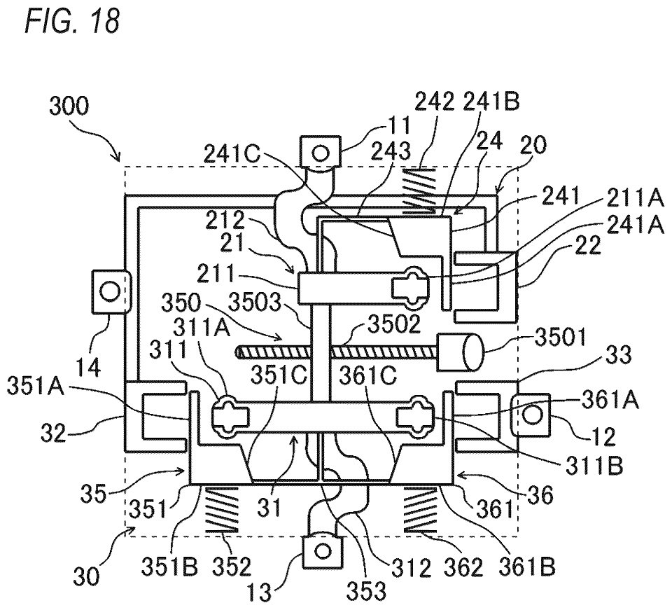

FIG. 18 is a diagram showing a battery switching device 300 according to another embodiment of the present disclosure. The battery switching device 300 shown in the drawing includes a drive and connection restriction mechanism 350. The drive and connection restriction mechanism 350 has functions equivalent to those of the first driving mechanism 23, the second driving mechanism 34, and the connection restriction mechanism 40 of the battery switching device 1 shown in FIG. 2 and the like. The same components as those of the above-described embodiment are denoted by the same reference numerals, and the description of the above-described embodiment is incorporated.

In the battery switching device 300, the first parallel contact 22 and the second parallel contact 33 are arranged in the up-down direction in the drawing, and the series contact 32 and the second parallel contact 33 are arranged in the left-right direction in the drawing. The first parallel contact 22, the series contact 32, and the fourth terminal 14 are integrally formed of a conductive material.

The drive and connection restriction mechanism 350 includes a motor 3501, a ball screw 3502, and a slider 3503. The ball screw 3502 is integrated with an output shaft of the motor 3501, and is disposed between the first conductor bar 211 and the second conductor bar 311 and is disposed parallel to the first conductor bar 211 and the second conductor bar 311.

The slider 3503 is a plate-shaped member extending in the up-down direction in the drawing, and is screwed to a screw portion of the ball screw 3502. One end side in the longitudinal direction of the slider 3503 is fixed to the other end side in the axial direction of the first conductor bar 211, and the other end side in the longitudinal direction of the slider 3503 is fixed to the central portion in the axial direction of the second conductor bar 311.

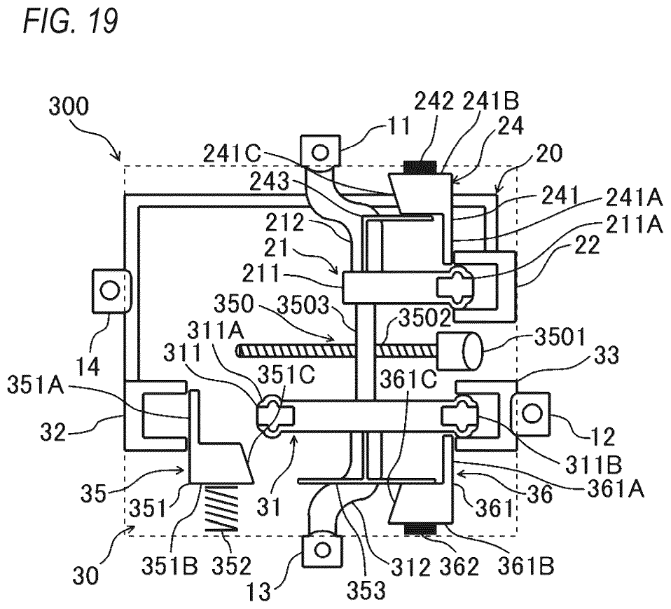

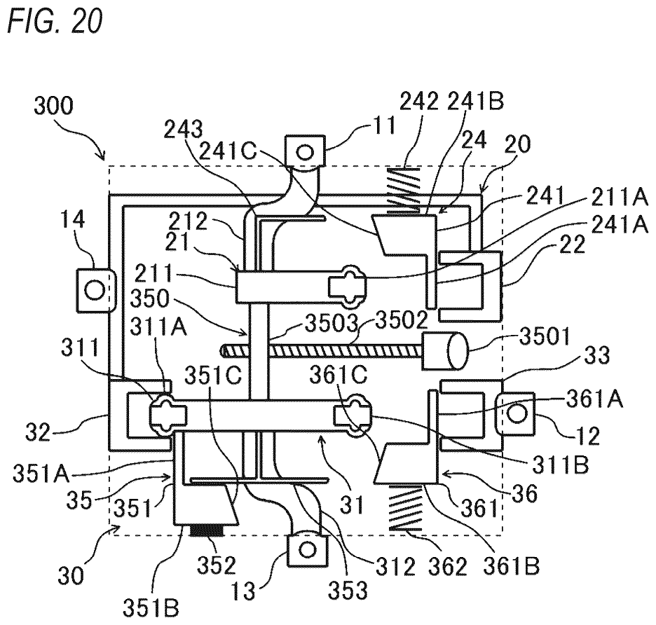

FIGS. 19 and 20 are diagrams showing an operation of the battery switching device 300 shown in FIG. 18. FIG. 19 shows a state where the first movable contact 21 and the first parallel contact 22 of the first contact device 20 are connected and the second movable contact 31 and the second parallel contact 33 of the second contact device 30 are connected.

As shown in FIG. 19, when the ball screw 3502 is rotated in one direction by the motor 3501, the slider 3503, the first conductor bar 211, and the second conductor bar 311 move toward the first parallel contact 22 and the second parallel contact 33. That is, when the first conductor bar 211 moves toward the first parallel contact 22, the second conductor bar 311 moves toward the second parallel contact 33. Therefore, the connection between the first movable contact 21 and the first parallel contact 22 of the first contact device 20 and the connection between the second movable contact 31 and the series contact 32 of the second contact device 30 are prevented from occurring simultaneously.

FIG. 20 shows a state where the second movable contact 31 and the series contact 32 of the second contact device 30 are connected and the first movable contact 21 and the first parallel contact 22 of the first contact device 20 are disconnected. As shown in this drawing, when the ball screw 3502 is rotated in the other direction by the motor 3501, the slider 3503, the first conductor bar 211, and the second conductor bar 311 move toward the series contact 32. That is, when the second conductor bar 311 moves toward the series contact 32, the first conductor bar 211 moves toward the side separated from the first parallel contact 22. Therefore, the connection between the first movable contact 21 and the first parallel contact 22 of the first contact device 20 and the connection between the second movable contact 31 and the series contact 32 of the second contact device 30 are prevented from occurring simultaneously.

As described above, in the battery switching device 300 according to the present embodiment, the drive and connection restriction mechanism 350 includes the slider 3503, the ball screw 3502 screwed with the slider 3503, and the motor 3501 that rotates the ball screw 3502. The slider 3503 is fixed to the first conductor bar 211 and the second conductor bar 311, and the ball screw 3502 is disposed parallel to the first conductor bar 211 and the second conductor bar 311.

In the battery switching device 300 according to the present embodiment, by the movement of the slider 3503 in the first direction, the first conductor bar 211 is moved in the first direction, and the first male contact 211A is connected to the first parallel contact 22. At this time, the second conductor bar 311 is moved in the first direction, the third male contact 311B is connected to the second parallel contact 33, and the second male contact 311A is separated from the series contact 32. On the other hand, by the movement of the slider 3503 in the second direction opposite to the first direction, the first conductor bar 211 is moved in the second direction, and the first male contact 211A is separated from the first parallel contact 22. At this time, the second conductor bar 311 is moved in the second direction, the second male contact 311A is connected to the series contact 32, and the third male contact 311B is separated from the second parallel contact 33.

Accordingly, when the first male contact 211A of the first conductor bar 211 is moved in the direction in which the first male contact 211A approaches the first parallel contact 22, the second conductor bar 311 is prevented from moving in the direction in which the second male contact 311A approaches the series contact 32. Further, when the second male contact 311A of the second conductor bar 311 is moved in the direction in which the second male contact 311A approaches the series contact 32, the first conductor bar 211 is prevented from moving in the direction in which the first male contact 211A approaches the first parallel contact 22. Therefore, according to the battery switching device 300 according to the present embodiment, the connection between the first movable contact 21 and the first parallel contact 22 of the first contact device 20 and the connection between the second movable contact 31 and the series contact 32 of the second contact device 30 occur simultaneously, the first battery module 2 or the second battery module 3 can be prevented from being short-circuited, and safety can be improved.

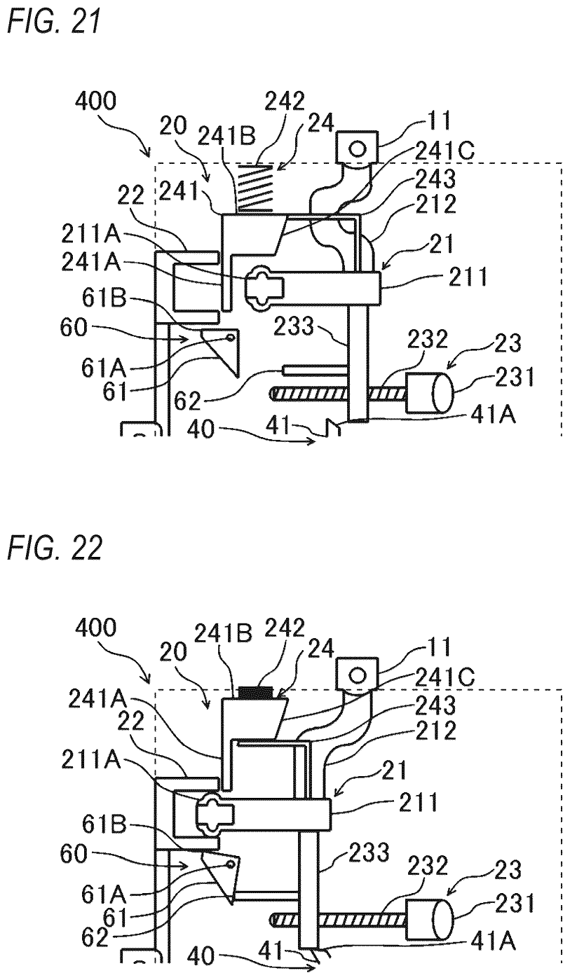

FIG. 21 is a diagram showing a battery switching device 400 according to another embodiment of the present disclosure. The battery switching device 400 shown in this drawing includes a pressurizing mechanism 60 that increases the contact pressure between the first male contact 211A of the first conductor bar 211 and the first parallel contact 22. The battery switching device 400 further includes a mechanism (not shown) for increasing the contact pressure between the second male contact 311A of the second conductor bar 311 and the series contact 32, and a mechanism (not shown) for increasing the contact pressure between the third male contact 311B of the second conductor bar 311 and the second parallel contact 33. A mechanism corresponding to the second male contact 311A and the third male contact 311B of the second conductor bar 311 has the same configuration as that of the pressurizing mechanism 60, and thus a description thereof will be omitted. The same components as those of the above-described embodiment are denoted by the same reference numerals, and the description of the above-described embodiment is incorporated.

In the battery switching device 400, similarly to the above-described battery switching device 1, the first parallel contact 22 and the series contact 32 are arranged in the up-down direction in the drawing, and the series contact 32 and the second parallel contact 33 are arranged in the left-right direction in the drawing. The first parallel contact 22, the series contact 32, and the fourth terminal 14 are integrally formed of an insulating material.

The pressurizing mechanism 60 includes a pressing member 61, a transmission member 62, and a biasing member (not shown). The pressing member 61 is a block having a right triangle shape when viewed in the front-rear direction in the drawing (a direction orthogonal to the movement direction of the first conductor bar 211 and the movement direction of the first shielding member 241). A rotary shaft 61A is inserted at a right angle to the pressing member 61. The rotary shaft 61A extends along the front-rear direction in the drawing. One of the two sides (hereinafter referred to as a first side) sandwiching a right angle of the pressing member 61 is close to an outer periphery surface of the first parallel contact 22, and the other of the two sides (hereinafter referred to as a second side) sandwiching the right angle of the pressing member 61 faces the first slider 233. The biasing member is a torsion coil spring and biases the pressing member 61 in the counterclockwise direction in the drawing.

The transmission member 62 is a rod member attached to the first slider 233. The transmission member 62 is disposed parallel to the first conductor bar 211, and a tip thereof is brought into contact with a second side of the pressing member 61. Here, the rotary shaft 61A (a fulcrum) is located on one end side (an upper side in the drawing) of the second side of the pressing member 61, and a force point at which the tip of the transmission member 62 and the pressing member 61 come into contact with each other is located on the other end side (a lower side in the drawing) of the second side of the pressing member 61.

FIG. 22 is a diagram showing an operation of the battery switching device 400 shown in FIG. 21. As shown in this drawing, when the transmission member 62 comes into contact with the second side of the pressing member 61 by the movement of the first slider 233, the pressing member 61 rotates in the clockwise direction in the drawing against the biasing force of the biasing member, and one end (a left side in the drawing) of the first side is brought into contact with the outer periphery surface of the first parallel contact 22. At this time, according to this principle, the force applied from the transmission member 62 to the pressing member 61 is amplified, and a pressing force operates on the first parallel contact 22 and the first male contact 211A from an acting point of the pressing member 61. Accordingly, the contact pressure between the first parallel contact 22 and the first male contact 211A increases.

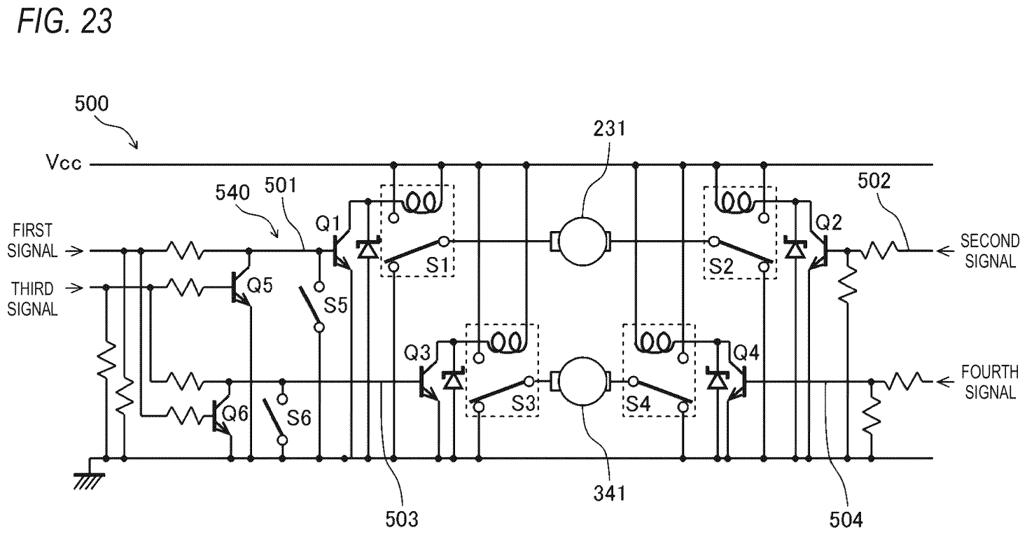

FIG. 23 is a circuit diagram showing a contact drive circuit 500 included in a battery switching device (not shown) according to another embodiment of the present disclosure. The contact drive circuit 500 shown in this drawing includes a connection restriction unit 540 instead of the connection restriction mechanism 40 of the battery switching device 1 shown in FIG. 2 and the like. The same components as those of the battery switching device 1 according to the above-described embodiment are denoted by the same reference numerals, and the description of the battery switching device 1 is incorporated by reference.

As shown in FIG. 23, the contact drive circuit 500 is a circuit that transmits or blocks signals to the first motor 231 and the second motor 341. The contact drive circuit 500 includes a first path 501 and a second path 502 that are signal transmission paths to the first motor 231, and a third path 503 and a fourth path 504 that are signal transmission paths to the second motor 341.

The first path 501 is a path through which a signal (hereinafter, a first signal) for moving the first conductor bar 211 toward the first parallel contact 22 is transmitted. The second path 502 is a path through which a signal (hereinafter referred to as a second signal) for moving the first conductor bar 211 toward the side separated from the first parallel contact 22 is transmitted. The first path 501 is provided with a first transistor Q1, a first switch S1, and the like. The second path 502 is provided with a second transistor Q2, a second switch S2, and the like.

The first transistor Q1 is a transistor such as a metal-oxide-semiconductor field-effect transistor (MOSFET) that is turned ON when the first signal is input. The first switch S1 is a changeover-contact switch such as a mechanical relay that connects the first motor 231 to a power supply Vcc and connects the first motor 231 to the ground.

A base of the first transistor Q1 is connected to an input terminal of the first path 501 via a resistor or the like, a collector of the first transistor Q1 is connected to the power supply Vcc via a coil of the first switch S1, and an emitter of the first transistor Q1 is connected to the ground.

A common terminal of the first switch S1 is connected to the first motor 231, a normally-closed terminal of the first switch S1 is connected to the ground, and a normally-open terminal of the first switch S1 is connected to the power supply Vcc. A coil of the first switch S1 is connected to the collector of the first transistor Q1 and the power supply Vcc.

The second transistor Q2 is a transistor such as a MOSFET that is turned ON when the second signal is input. The second switch S2 is a changeover-contact switch such as a mechanical relay that connects the first motor 231 to the power supply Vcc and connects the first motor 231 to the ground.

A base of the second transistor Q2 is connected to an input terminal of the second path 502 via a resistor or the like, a collector of the second transistor Q2 is connected to the power supply Vcc via a coil of the second switch S2, and an emitter of the second transistor Q2 is connected to the ground.

A common terminal of the second switch S2 is connected to the first motor 231, a normally-closed terminal of the second switch S2 is connected to the ground, and a normally-open terminal of the second switch S2 is connected to the power supply Vcc. A coil of the second switch S2 is connected to the collector of the second transistor Q2 and the power supply Vcc.

The third path 503 is a path through which a signal (hereinafter referred to as a third signal) for moving the second conductor bar 311 toward the series contact 32 is transmitted. The fourth path 504 is a path through which a signal (hereinafter, referred to as a fourth signal) for moving the second conductor bar 311 to a side (a second parallel contact 33 side) separated from the series contact 32 is transmitted. The third path 503 is provided with a third transistor Q3, a third switch S3, and the like. The fourth path 504 is provided with a fourth transistor Q4, a fourth switch S4, and the like.

The third transistor Q3 is a transistor such as a MOSFET that is turned ON when the third signal is input. The third switch S3 is a changeover-contact switch such as a mechanical relay that connects the second motor 341 to the power supply Vcc and connects the second motor 341 to the ground.

A base of the third transistor Q3 is connected to an input terminal of the third path 503 via a resistor or the like, a collector of the third transistor Q3 is connected to the power supply Vcc via a coil of the third switch S3, and an emitter of the third transistor Q3 is connected to the ground.

A common terminal of the third switch S3 is connected to the second motor 341, a normally-closed terminal of the third switch S3 is connected to the ground, and a normally-open terminal of the third switch S3 is connected to the power supply Vcc. A coil of the third switch S3 is connected to the collector of the third transistor Q3 and the power supply Vcc.

The fourth transistor Q4 is a transistor such as a MOSFET that is turned ON when the fourth signal is input. The fourth switch S4 is a changeover-contact switch such as a mechanical relay that connects the second motor 341 to the power supply Vcc and connects the second motor 341 to the ground.

A base of the fourth transistor Q4 is connected to an input terminal of the fourth path 504 via a resistor or the like, a collector of the fourth transistor Q4 is connected to the power supply Vcc via a coil of the fourth switch S4, and an emitter of the fourth transistor Q4 is connected to the ground.

A common terminal of the fourth switch S4 is connected to the second motor 341, a normally-closed terminal of the fourth switch S4 is connected to the ground, and a normally-open terminal of the fourth switch S4 is connected to the power supply Vcc. The coil of the fourth switch S4 is connected to the collector of the fourth transistor Q4 and the power supply Vcc.

The connection restriction unit 540 includes a fifth switch S5, a sixth switch S6, a fifth transistor Q5, and a sixth transistor Q6, and prevents the first switch S1 and the third switch S3 from being simultaneously turned ON.

The fifth switch S5 is a microswitch, a photoelectric switch, a magnetic switch, or the like. The fifth switch S5 is turned ON when the second male contact 311A of the second conductor bar 311 moves to the series contact 32, and is turned OFF when the second male contact 311A is separated from the series contact 32. One end of the fifth switch S5 is connected to the first path 501. A connection point between one end of the fifth switch S5 and the first path 501 is located between the input terminal of the first path 501 and the base of the first transistor Q1. The other end of the fifth switch S5 is connected to the ground. A configuration for turning ON/OFF the fifth switch S5 will be described later.

The sixth switch S6 is a microswitch, a photoelectric switch, a magnetic switch, or the like. The sixth switch S6 is turned ON when the first male contact 211A of the first conductor bar 211 moves to the first parallel contact 22, and is turned OFF when the first male contact 211A is separated from the first parallel contact 22. One end of the sixth switch S6 is connected to the third path 503. A connection point between one end of the sixth switch S6 and the third path 503 is located between the input terminal of the third path 503 and the base of the third transistor Q3. The other end of the sixth switch S6 is connected to the ground. A configuration for turning ON/OFF the sixth switch S6 will be described later.

The fifth transistor Q5 is a transistor such as a MOSFET that is turned ON when the third signal is input. A base of the fifth transistor Q5 is connected to the third path 503 via a resistor, a collector of the fifth transistor Q5 is connected to the first path 501, and an emitter of the fifth transistor Q5 is connected to the ground.

The sixth transistor Q6 is a transistor such as a MOSFET that is turned ON when the first signal is input. A base of the sixth transistor Q6 is connected to the first path 501 via a resistor, a collector of the sixth transistor Q6 is connected to the third path 503, and an emitter of the sixth transistor Q6 is connected to the ground.

A connection point between the base of the sixth transistor Q6 and the first path 501 is located between a connection point between the collector of the fifth transistor Q5 and the first path 501 and the input terminal of the first path 501. A connection point between one end of the fifth switch S5 and the first path 501 is located between a connection point between the base of the first transistor Q1 and the first path 501 and the connection point between the collector of the fifth transistor Q5 and the first path 501.

A connection point between the base of the fifth transistor Q5 and the third path 503 is located between a connection point between the collector of the sixth transistor Q6 and the third path 503 and the input terminal of the third path 503. The connection point between one end of the sixth switch S6 and the third path 503 is located between a connection point between the base of the third transistor Q3 and the third path 503 and the connection point between the collector of the sixth transistor Q6 and the third path 503.

A connection point between the emitter of the sixth transistor Q6 and a ground line is located between a connection point between the emitter of the fifth transistor Q5 and the ground line and a ground terminal. A connection point between the other end of the sixth switch S6 and the ground line is located between a connection point between the other end of the fifth switch S5 and the ground line and the connection point between the emitter of the fifth transistor Q5 and the ground line. The connection point between the other end of the fifth switch S5 and the ground line is located between a connection point between the emitter of the first transistor Q1 and the ground line and a connection point between the other end of the sixth switch S6 and the ground line.

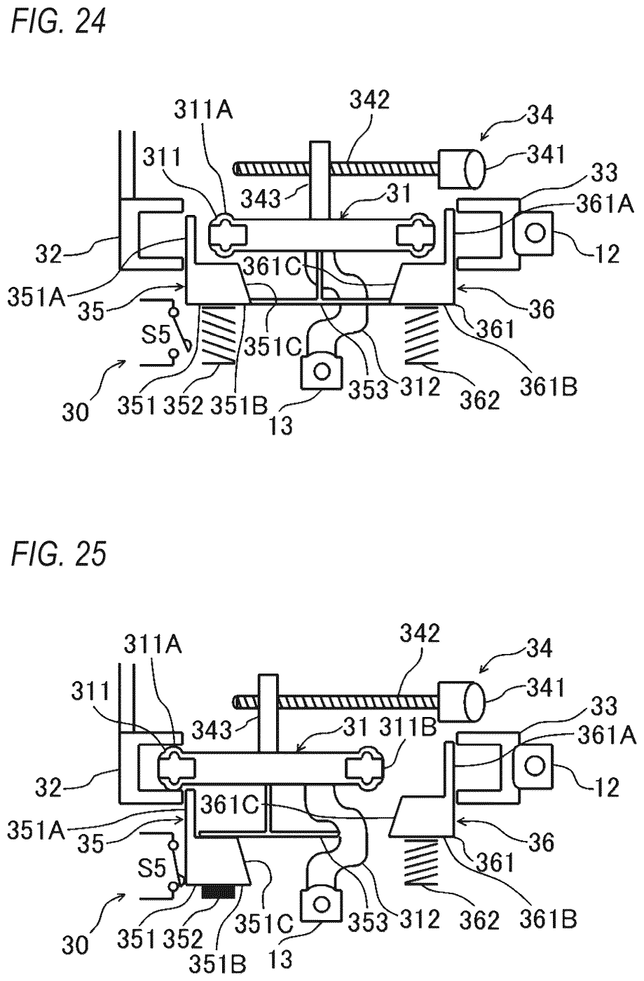

FIG. 24 shows a configuration for turning ON/OFF the fifth switch S5 shown in FIG. 23. The fifth switch S5 shown in this drawing is a microswitch, is disposed in the vicinity of the second shielding member 351, and is turned ON/OFF in conjunction with the movement of the second shielding member 351. A configuration for turning ON/OFF the sixth switch S6 is similar to a configuration for turning ON/OFF the fifth switch S5. The sixth switch S6 is disposed in the vicinity of the first shielding member 241, and is turned ON/OFF in conjunction with the movement of the first shielding member 241.

A movable contact of the fifth switch S5 is separated from the second shielding member 351 in a state of shielding the series contact 32. Therefore, in a state where the second male contact 311A of the second conductor bar 311 is separated from the series contact 32, the second shielding member 351 is separated from the movable contact of the fifth switch S5, and the fifth switch S5 is turned OFF.

FIG. 25 is a diagram illustrating an operation of the configuration shown in FIG. 24. As shown in this drawing, when the second shielding member 351 is retracted from the shielding position by the movement of the second conductor bar 311 toward the series contact 32, the second shielding member 351 presses down the movable contact of the fifth switch S5, and the fifth switch S5 is turned ON.

As shown in FIG. 23, when the first signal is input to the first path 501, the first transistor Q1 is turned ON, and the first motor 231 is driven to move the first conductor bar 211 toward the first parallel contact 22. At this time, even when the third signal is input to the third path 503 by turning ON the sixth transistor Q6, the third signal passes through the sixth transistor Q6 and reaches the ground. That is, while the first signal is input to the first motor 231 through the first path 501, the third signal is prevented from being input to the second motor 341 through the third path 503. Therefore, while the first motor 231 is driven to move the first conductor bar 211 toward the first parallel contact 22, the second motor 341 is prevented from being driven to move the second conductor bar 311 toward the series contact 32.

When the first male contact 211A of the first conductor bar 211 moves to the first parallel contact 22, the sixth switch S6 is turned ON by the first shielding member 241, and the input of the first signal to the first path 501 is stopped. At this time, when the third signal is input to the third path 503, the third signal passes through the sixth switch S6 and reaches the ground. That is, while the sixth switch S6 is turned ON, the third signal is prevented from being input to the second motor 341 through the third path 503. Therefore, while the first male contact 211A of the first conductor bar 211 is fitted to the first parallel contact 22, the second motor 341 is prevented from being driven to move the second conductor bar 311 toward the series contact 32.

When the third signal is input to the third path 503, the third transistor Q3 is turned ON, and the second motor 341 is driven to move the second conductor bar 311 toward the series contact 32. At this time, even when the first signal is input to the first path 501 by turning ON the fifth transistor Q5, the first signal passes through the fifth transistor Q5 and reaches the ground. That is, while the third signal is input to the second motor 341 through the third path 503, the first signal is prevented from being input to the first motor 231 through the first path 501. Therefore, while the second motor 341 is driven to move the second conductor bar 311 toward the series contact 32, the first motor 231 is prevented from being driven to move the first conductor bar 211 toward the first parallel contact 22.

When the second male contact 311A of the second conductor bar 311 moves to the series contact 32, the fifth switch S5 is turned ON by the second shielding member 351, and the input of the third signal to the third path 503 is stopped. At this time, when the first signal is input to the first path 501, the first signal passes through the fifth switch S5 and reaches the ground. That is, while the fifth switch S5 is turned ON, the first signal is prevented from being input to the first motor 231 through the first path 501. Therefore, while the second male contact 311A of the second conductor bar 311 is fitted to the series contact 32, the first motor 231 is prevented from being driven to move the first conductor bar 211 toward the first parallel contact 22.

As described above, in the battery switching device according to the present embodiment, the first motor 231 is driven in accordance with the first signal and the second signal, and the second motor 341 is driven in accordance with the third signal and the fourth signal. The first signal is a signal for moving the first conductor bar 211 in the direction in which the first male contact 211A approaches the first parallel contact 22. The second signal is a signal for moving the first conductor bar 211 in a direction in which the first male contact 211A is separated from the first parallel contact 22. The third signal is a signal for moving the second conductor bar 311 in a direction in which the second male contact 311A approaches the series contact 32 and the third male contact 311B is separated from the second parallel contact 33. The fourth signal is a signal for moving the second conductor bar 311 in a direction in which the third male contact 311B approaches the second parallel contact 33 and the second male contact 311A is separated from the series contact 32.

In the battery switching device according to the present embodiment, the connection restriction unit 540 includes the fifth transistor Q5, the sixth transistor Q6, the fifth switch S5, and the sixth switch S6. The sixth transistor Q6 blocks the third signal output to the second motor 341 while the first signal is input to the first motor 231. The fifth transistor Q5 blocks the first signal output to the first motor 231 while the third signal is input to the second motor 341. Accordingly, when the first conductor bar 211 moves in the direction in which the first male contact 211A approaches the first parallel contact 22, the second conductor bar 311 can be prevented from moving in the direction in which the second male contact 311A approaches the series contact 32. Further, when the second conductor bar 311 moves in the direction in which the second male contact 311A approaches the series contact 32, the first conductor bar 211 can be prevented from moving in the direction in which the first male contact 211A approaches the first parallel contact 22.

The sixth switch S6 blocks the third signal output to the second motor 341 while the first male contact 211A is connected to the first parallel contact 22. Further, the fifth switch S5 blocks the first signal output to the first motor 231 while the second male contact 311A is connected to the series contact 32. Accordingly, in a state where the first male contact 211A is connected to the first parallel contact 22 and the output of the first signal is stopped, the second conductor bar 311 can be prevented from moving in the direction in which the second male contact 311A approaches the series contact 32. Further, in a state where the second male contact 311A is connected to the series contact 32 and the output of the third signal is stopped, the first conductor bar 211 can be prevented from moving in the direction in which the first male contact 211A approaches the first parallel contact 22.

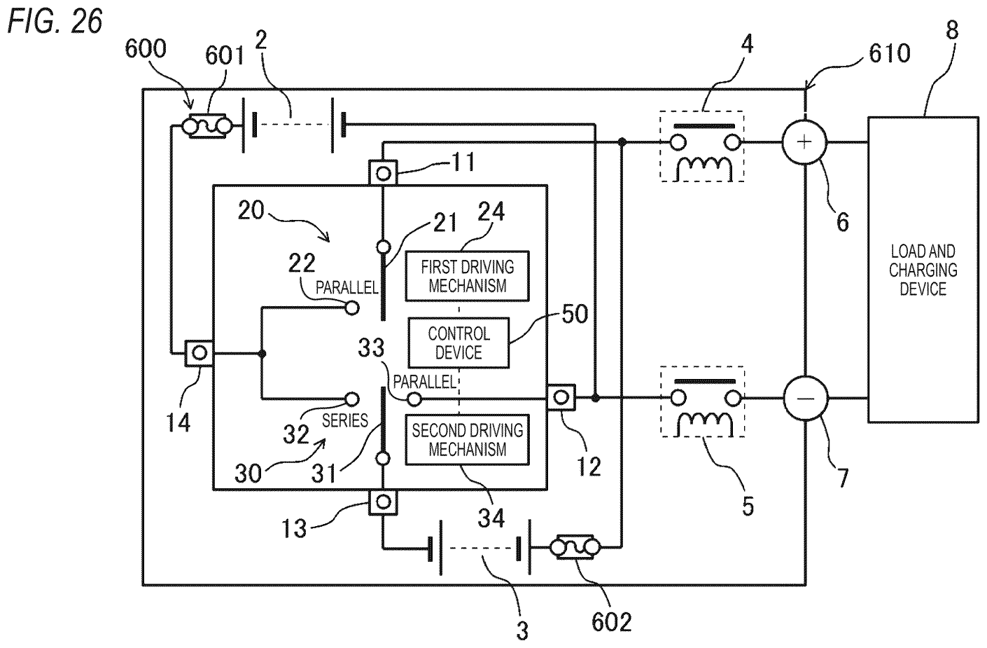

FIG. 26 is a circuit diagram showing a battery switching device 600 and a battery system 610 including the battery switching device 600 according to another embodiment of the present disclosure. The battery switching device 600 shown in this drawing includes a first fuse 601 and a second fuse 602 instead of the connection restriction mechanism 40 of the battery switching device 1 according to the above-described embodiment. The same components as those of the battery switching device 1 are denoted by the same reference numerals, and the description of the battery switching device 1 is incorporated by reference.

The first fuse 601 is provided between the positive electrode of the first battery module 2 and the fourth terminal 14. The second fuse 602 is provided between the positive electrode of the second battery module 3 and the first terminal 11 and the first main relay 4. The first fuse 601 and the second fuse 602 are a fusing fuse that opens a circuit by being melted by heat of a short-circuit current, a pyro-fuse that detects a short-circuit current and opens a circuit by a breaking force of an explosive, or the like.

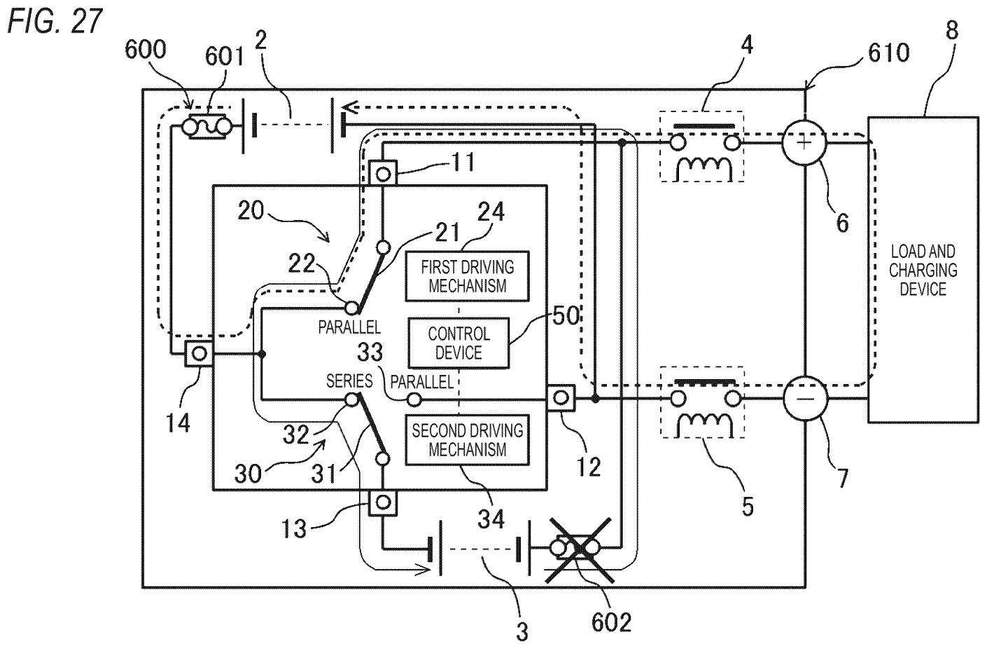

FIG. 27 is a circuit diagram showing an operation of the battery system 610 shown in FIG. 26. As shown in this drawing, when the second movable contact 31 is connected to the series contact 32 in a state where the first movable contact 21 is connected to the first parallel contact 22, a current for short-circuiting the second battery module 3 flows as indicated by a solid arrow in the drawing. At this time, the second fuse 602 melts or breaks, so that a circuit that short-circuits the second battery module 3 is opened. Accordingly, when the second movable contact 31 is connected to the series contact 32 in a state where the first movable contact 21 is connected to the first parallel contact 22, energization by the first battery module 2 can be continued.

Although not shown, when the first movable contact 21 is connected to the first parallel contact 22 in a state where the second movable contact 31 is connected to the series contact 32, a current that short-circuits the first battery module 2 flows. At this time, the first fuse 601 melts or breaks, so that a circuit that short-circuits the first battery module 2 is opened. Accordingly, when the first movable contact 21 is connected to the first parallel contact 22 in the state where the second movable contact 31 is connected to the series contact 32, energization by the second battery module 3 can be continued.

As described above, in the battery switching device 600 according to the present embodiment, the first battery module 2 is connected to the first parallel contact 22, the series contact 32, and the second parallel contact 33, and the second battery module 3 is connected to the first movable contact 21 and the second movable contact 31. In the battery switching device 600, the first fuse 601 is provided on a power line connecting the first parallel contact 22, the series contact 32, and the first battery module 2. The second fuse 602 is provided on a power line connecting the first movable contact 21 and the second battery module 3.

Accordingly, when the current that short-circuits the first battery module 2 flows, a circuit through which the current flows can be opened by the first fuse 601, and when the current that short-circuits the second battery module 3 flows, a circuit through which the current flows can be opened by the second fuse 602. Therefore, energization by at least one of the first battery module 2 and the second battery module 3 can be continued.

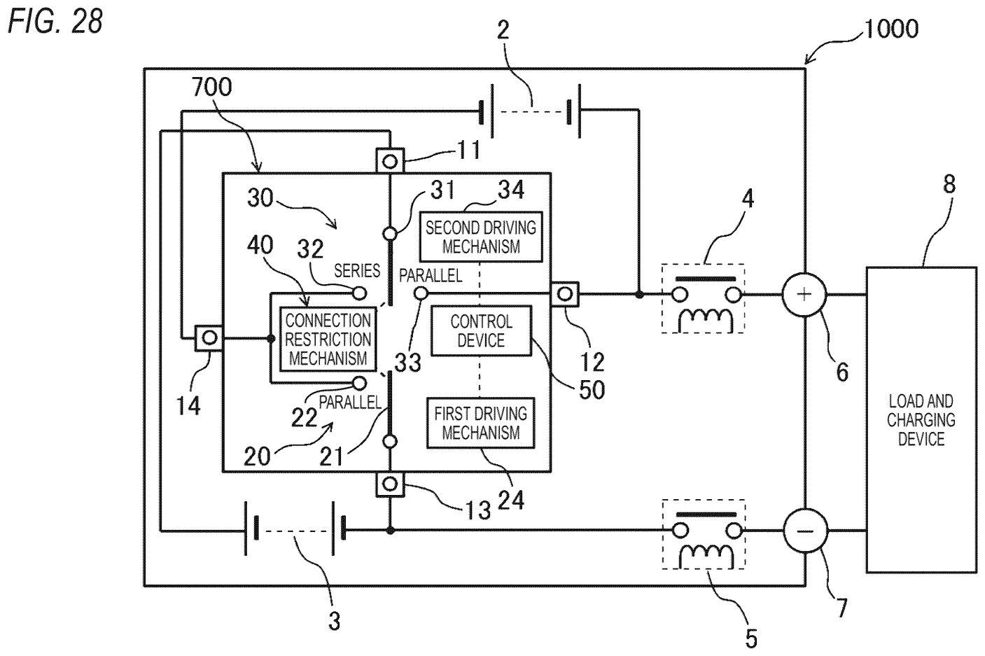

FIG. 28 is a circuit diagram showing a battery switching device 700 and a battery system 1000 including the battery switching device 700 according to another embodiment of the present disclosure. The same components as those of the battery system 10 according to the above-described embodiment are denoted by the same reference numerals, and the description of the battery system 10 is incorporated by reference.

In the battery system 1000 shown in FIG. 28, the positive electrode of the first battery module 2 is connected between the second terminal 12 and the first main relay 4, and the negative electrode of the first battery module 2 is connected to the fourth terminal 14. The positive electrode of the second battery module 3 is connected to the first terminal 11, and the negative electrode of the second battery module 3 is connected to the third terminal 13 and the second main relay 5.

The first movable contact 21 of the first contact device 20 is connected to the third terminal 13. A common terminal of the second movable contact 31 of the second contact device 30 is connected to the first terminal 11. The first parallel contact 22 and the series contact 32 are connected to the fourth terminal 14, and the second parallel contact 33 is connected to the second terminal 12.

The first battery module 2 and the second battery module 3 are connected in parallel in the state where the first movable contact 21 and the first parallel contact 22 are connected and the second movable contact 31 and the second parallel contact 33 are connected. On the other hand, the first battery module 2 and the second battery module 3 are connected in series in the state where the first movable contact 21 and the first parallel contact 22 are disconnected and the second movable contact 31 and the series contact 32 are connected.

The connection restriction mechanism 40 prevents the second movable contact 31 from being connected to the series contact 32 in the state where the first movable contact 21 and the first parallel contact 22 are connected. The connection restriction mechanism 40 prevents the first movable contact 21 from being connected to the first parallel contact 22 in the state where the second movable contact 31 and the series contact 32 are connected.

The present disclosure has been described above based on the above-described embodiments, but the present disclosure is not limited to the embodiments described above, and modifications may be made to the embodiments described above, and publicly known or well-known techniques may be appropriately combined within a scope not departing from the spirit of the present disclosure.

According to a first aspect of the present disclosure, a battery switching device (1) includes: a first contact device (20) including a first movable contact (21) and a first parallel contact (22) to which the first movable contact (21) is connected or disconnected; and a second contact device (30) including a second movable contact (31), a series contact (32) to which the second movable contact (31) is connected or disconnected, and a second parallel contact (33) to which the second movable contact (31) is connected or disconnected. A first battery (2) and a second battery (3) are connected in series by disconnecting the first movable contact (21) from the first parallel contact (22), disconnecting the second movable contact (31) from the second parallel contact (33), and connecting the second movable contact (31) to the series contact (32). The first battery (2) and the second battery (3) are connected in parallel by connecting the first movable contact (21) and the first parallel contact (22), connecting the second movable contact (31) and the second parallel contact (33), and disconnecting the second movable contact (31) and the series contact (32). The first movable contact (21) includes a first conductor bar (211) provided to be linearly movable along an axial direction and provided with a first male contact (211A) at one end in the axial direction. The first parallel contact (22) is a female contact to which the first male contact (211A) is connected or separated by linear movement of the first conductor bar (211). The second movable contact (31) includes a second conductor bar (311) provided to be linearly movable along the axial direction and provided with a second male contact (311A) at one end in the axial direction and a third male contact (311B) at the other end in the axial direction. The series contact (32) is a female contact to which the second male contact (311A) is connected or separated by linear movement of the second conductor bar (311). The second parallel contact (33) is a female contact to which the third male contact (311B) is connected or separated by linear movement of the second conductor bar (311). The battery switching device (1) further includes a connection restriction unit (540) configured to prevent the second male contact (311A) from being connected to the series contact (32) in a state where the first male contact (211A) is connected to the first parallel contact (22) and prevent the first male contact (211A) from being connected to the first parallel contact (22) in a state where the second male contact (311A) is connected to the series contact (32).

According to a second aspect of the present disclosure, in the battery switching device (1) of the first aspect, the first contact device (20) includes: a first slider (233) fixed to the first conductor bar (211); a first ball screw (232) screwed with the first slider (233); and a first motor (231) configured to rotate the first ball screw (232) to linearly move the first slider (233) in a first direction and a second direction opposite to the first direction. The second contact device (30) includes: a second slider (343) fixed to the second conductor bar (311); a second ball screw (342) disposed parallel to the first ball screw (232) and screwed with the second slider (343); and a second motor (341) configured to rotate the second ball screw (342) to linearly move the second slider (343) in the first direction and the second direction. The first male contact (211A) is connected to the first parallel contact (22) by movement of the first slider (233) in the first direction, and the first male contact (211A) is separated from the first parallel contact (22) by movement of the first slider (233) in the second direction. The second male contact (311A) is connected to the series contact (32) and the third male contact (311B) is separated from the second parallel contact (33) by the movement of the second slider (343) in the first direction, and the third male contact (311B) is connected to the second parallel contact (33) and the second male contact (311A) is separated from the series contact (32) by the movement of the second slider (343) in the second direction. The connection restriction unit (540) includes: a rotary member (41) that is rotated to a position where the movement of the second slider (343) in the first direction is prevented by the movement of the first slider (233) in the first direction and is rotated to a position where the movement of the first slider (233) in the first direction is prevented by the movement of the second slider (343) in the first direction.

According to a third aspect of the present disclosure, in the battery switching device (1) of the first aspect, the first contact device (20) includes: a first slider (233) fixed to the first conductor bar (211); a first ball screw (232) screwed with the first slider (233); and a first motor (231) configured to rotate the first ball screw (232) to linearly move the first slider (233) in a first direction and a second direction opposite to the first direction. The second contact device (30) includes: a second slider (343) fixed to the second conductor bar (311); a second ball screw (342) disposed parallel to the first ball screw (232) and screwed with the second slider (343); and a second motor (341) configured to rotate the second ball screw (342) to linearly move the second slider (343) in the first direction and the second direction. The first male contact (211A) is connected to the first parallel contact (22) by movement of the first slider (233) in the first direction, and the first male contact (211A) is separated from the first parallel contact (22) by movement of the first slider (233) in the second direction. The third male contact (311B) is connected to the second parallel contact (33) and the second male contact (311A) is separated from the series contact (32) by the movement of the second slider (343) in the first direction, and the second male contact (311A) is connected to the series contact (32) and the third male contact (311B) is separated from the second parallel contact (33) by the movement of the second slider (343) in the second direction. The connection restriction unit (540) includes: a first shaft portion (142) fixed to the first slider (233), a second shaft portion (143) fixed to the second slider (343), and a link (141) has a first long hole (141A) through which the first shaft portion (142) is slidably inserted and a second long hole (141B) through which the second shaft portion (143) is slidably inserted.

According to a fourth aspect of the present disclosure, in the battery switching device (1) of the first aspect, the connection restriction unit (540) includes: a worm wheel (253); a worm (252) meshed with the worm wheel (253); a motor (251) configured to rotate the worm (252); and a pair of shaft portions (256, 257) disposed symmetrically with respect to a rotary shaft of the worm wheel (253) and fixed to the worm wheel (253); a first member fixed to the first conductor bar (211) and having a first long hole (141A) through which one of the pair of shaft portions (256, 257) is slidably inserted; and a second member fixed to the second conductor bar (311) and having a second long hole (141B) through which the other of the pair of shaft portions (256, 257) is slidably inserted. By rotation of the worm wheel (253) in a first rotation direction, the first conductor bar (211) is moved in a first direction such that the first male contact (211A) is connected to the first parallel contact (22), and the second conductor bar (311) is moved in a second direction opposite to the first direction such that the third male contact (311B) is connected to the second parallel contact (33) and the second male contact (311A) is separated from the series contact (32). By rotation of the worm wheel (253) in a second rotation direction opposite to the first rotation direction, the first conductor bar (211) is moved in the second direction such that the first male contact (211A) is separated from the first parallel contact (22), and the second conductor bar (311) is moved in the first direction such that the second male contact (311A) is connected to the series contact (32) and the third male contact (311B) is separated from the second parallel contact (33).

According to a fifth aspect of the present disclosure, in the battery switching device (1) of the first aspect, the connection restriction unit (540) includes: a slider (3503) fixed to the first conductor bar (211) and the second conductor bar (311); a ball screw (3502) disposed parallel to the first conductor bar (211) and the second conductor bar (311) and screwed with the slider (3503); and a motor (3501) configured to rotate the ball screw (3502) to linearly move the slider (3503) in a first direction and a second direction opposite to the first direction. By the movement of the slider (3503) in the first direction, the first conductor bar (211) is moved in the first direction such that the first male contact (211A) is connected to the first parallel contact (22), and the second conductor bar (311) is moved in the first direction such that the third male contact (311B) is connected to the second parallel contact (33) and the second male contact (311A) is separated from the series contact (32). By the movement of the slider (3503) in the second direction, the first conductor bar (211) is moved in the second direction such that the first male contact (211A) is separated from the first parallel contact (22), and the second conductor bar (311) is moved in the second direction such that the second male contact (311A) is connected to the series contact (32) and the third male contact (311B) is separated from the second parallel contact (33).

According to a sixth aspect of the present disclosure, in the battery switching device (1) of the first aspect, the first contact device (20) includes: a first slider (233) fixed to the first conductor bar (211); a first ball screw (232) screwed with the first slider (233); and a first motor (231) configured to rotate the first ball screw (232) in accordance with a first signal for moving the first conductor bar (211) in a direction in which the first male contact (211A) approaches the first parallel contact (22) and a second signal for moving the first conductor bar (211) in a direction in which the first male contact (211A) is separated from the first parallel contact (22). The second contact device (30) includes: a second slider (343) fixed to the second conductor bar (311); a second ball screw (342) screwed with the second slider (343); and a second motor (341) configured to rotate the second ball screw (342) in accordance with a third signal for moving the second conductor bar (311) in a direction in which the second male contact (311A) approaches the series contact (32) and the third male contact (311B) is separated from the second parallel contact (33) and a fourth signal for moving the second conductor bar (311) in a direction in which the third male contact (311B) approaches the second parallel contact (33) and the second male contact (311A) is separated from the series contact (32). The connection restriction unit (540) includes: a first switch (S1) configured to block the third signal output to the second motor (341) while the first signal is input to the first motor (231); a second switch (S2) configured to block the first signal output to the first motor (231) while the third signal is input to the second motor (341); a third switch (S3) configured to block the third signal output to the second motor (341) while the first male contact (211A) is connected to the first parallel contact (22); and a fourth switch (S4) configured to block the first signal output to the first motor (231) while the second male contact (311A) is connected to the series contact (32).

According to a seventh aspect of the present disclosure, in the battery switching device (1) of the first aspect, the first battery (2) is connected to the first parallel contact (22), the series contact (32), and the second parallel contact (33). The second battery (3) is connected to the first movable contact (21) and the second movable contact (31). The connection restriction unit (540) includes: a first fuse (601) provided on a power line connecting the first parallel contact (22), the series contact (32), and the first battery (2); and a second fuse (602) provided on a power line connecting the first movable contact (21) and the second battery (3).

According to an eighth aspect of the present disclosure, the battery switching device (1) of the first aspect further includes: an insulating first shielding member (241) disposed movably between a first shielding position for shielding the first parallel contact (22) and a first open position for opening the first parallel contact (22); an insulating second shielding member (351) disposed movably between a second shielding position for shielding the series contact (32) and a second open position for opening the series contact (32); an insulating third shielding member (361) disposed movably between a third shielding position for shielding the second parallel contact (33) and a third open position for opening the second parallel contact (33); a first driving mechanism (23) configured to move the first shielding member (241) from the first shielding position to the first open position in conjunction with movement of the first conductor bar (211) in a direction in which the first male contact (211A) approaches the first parallel contact (22), and move the first shielding member (241) from the first open position to the first shielding position in conjunction with movement of the first conductor bar (211) in a direction in which the first male contact (211A) is separated from the first parallel contact (22); and a second driving mechanism (34) configured to move the second shielding member (351) from the second shielding position to the second open position and move the third shielding member (361) from the third open position to the third shielding position in conjunction with movement of the second conductor bar (311) in a direction in which the second male contact (311A) approaches the series contact (32), and move the second shielding member (351) from the second open position to the second shielding position and move the third shielding member (361) from the third shielding position to the third open position in conjunction with movement of the second conductor bar (311) in a direction in which the third male contact (311B) approaches the second parallel contact (33).

What is claimed is:

1. A battery switching device comprising:
a first contact device including a first movable contact and a first parallel contact to which the first movable contact is connected or disconnected; and
a second contact device including a second movable contact, a series contact to which the second movable contact is connected or disconnected, and a second parallel contact to which the second movable contact is connected or disconnected, wherein
a first battery and a second battery are connected in series by disconnecting the first movable contact from the first parallel contact, disconnecting the second movable contact from the second parallel contact, and connecting the second movable contact to the series contact,
the first battery and the second battery are connected in parallel by connecting the first movable contact and the first parallel contact, connecting the second movable contact and the second parallel contact, and disconnecting the second movable contact and the series contact,
the first movable contact includes a first conductor bar provided to be linearly movable along an axial direction and provided with a first male contact at one end in the axial direction,
the first parallel contact is a female contact to which the first male contact is connected or separated by linear movement of the first conductor bar,
the second movable contact includes a second conductor bar provided to be linearly movable along the axial direction and provided with a second male contact at one end in the axial direction and a third male contact at the other end in the axial direction,
the series contact is a female contact to which the second male contact is connected or separated by linear movement of the second conductor bar,
the second parallel contact is a female contact to which the third male contact is connected or separated by linear movement of the second conductor bar, and
the battery switching device further comprises a connection restriction unit configured to prevent the second male contact from being connected to the series contact in a state where the first male contact is connected to the first parallel contact and prevent the first male contact from being connected to the first parallel contact in a state where the second male contact is connected to the series contact.

2. The battery switching device according to claim 1, wherein
the first contact device includes:
a first slider fixed to the first conductor bar;
a first ball screw screwed with the first slider; and
a first motor configured to rotate the first ball screw to linearly move the first slider in a first direction and a second direction opposite to the first direction,
the second contact device includes:
a second slider fixed to the second conductor bar;
a second ball screw disposed parallel to the first ball screw and screwed with the second slider; and
a second motor configured to rotate the second ball screw to linearly move the second slider in the first direction and the second direction, and
the first male contact is connected to the first parallel contact by movement of the first slider in the first direction, and the first male contact is separated from the first parallel contact by movement of the first slider in the second direction,
the second male contact is connected to the series contact and the third male contact is separated from the second parallel contact by the movement of the second slider in the first direction, and the third male contact is connected to the second parallel contact and the second male contact is separated from the series contact by the movement of the second slider in the second direction, and
the connection restriction unit includes:
a rotary member that is rotated to a position where the movement of the second slider in the first direction is prevented by the movement of the first slider in the first direction and is rotated to a position where the movement of the first slider in the first direction is prevented by the movement of the second slider in the first direction.

3. The battery switching device according to claim 1, wherein
the first contact device includes:
a first slider fixed to the first conductor bar;
a first ball screw screwed with the first slider; and
a first motor configured to rotate the first ball screw to linearly move the first slider in a first direction and a second direction opposite to the first direction,
the second contact device includes:
a second slider fixed to the second conductor bar;
a second ball screw disposed parallel to the first ball screw and screwed with the second slider; and
a second motor configured to rotate the second ball screw to linearly move the second slider in the first direction and the second direction,
the first male contact is connected to the first parallel contact by movement of the first slider in the first direction, and the first male contact is separated from the first parallel contact by movement of the first slider in the second direction,
the third male contact is connected to the second parallel contact and the second male contact is separated from the series contact by the movement of the second slider in the first direction, and the second male contact is connected to the series contact and the third male contact is separated from the second parallel contact by the movement of the second slider in the second direction, and
the connection restriction unit includes:
a first shaft portion fixed to the first slider,
a second shaft portion fixed to the second slider, and
a link has a first long hole through which the first shaft portion is slidably inserted and a second long hole through which the second shaft portion is slidably inserted.

4. The battery switching device according to claim 1, wherein
the connection restriction unit includes:
a worm wheel;
a worm meshed with the worm wheel;
a motor configured to rotate the worm;
a pair of shaft portions disposed symmetrically with respect to a rotary shaft of the worm wheel and fixed to the worm wheel;
a first member fixed to the first conductor bar and having a first long hole through which one of the pair of shaft portions is slidably inserted; and
a second member fixed to the second conductor bar and having a second long hole through which the other of the pair of shaft portions is slidably inserted,
by rotation of the worm wheel in a first rotation direction, the first conductor bar is moved in a first direction such that the first male contact is connected to the first parallel contact, and the second conductor bar is moved in a second direction opposite to the first direction such that the third male contact is connected to the second parallel contact and the second male contact is separated from the series contact, and
by rotation of the worm wheel in a second rotation direction opposite to the first rotation direction, the first conductor bar is moved in the second direction such that the first male contact is separated from the first parallel contact, and the second conductor bar is moved in the first direction such that the second male contact is connected to the series contact and the third male contact is separated from the second parallel contact.

5. The battery switching device according to claim 1, wherein
the connection restriction unit includes:
a slider fixed to the first conductor bar and the second conductor bar;
a ball screw disposed parallel to the first conductor bar and the second conductor bar and screwed with the slider; and
a motor configured to rotate the ball screw to linearly move the slider in a first direction and a second direction opposite to the first direction, and
by the movement of the slider in the first direction, the first conductor bar is moved in the first direction such that the first male contact is connected to the first parallel contact, and the second conductor bar is moved in the first direction such that the third male contact is connected to the second parallel contact and the second male contact is separated from the series contact, and
by the movement of the slider in the second direction, the first conductor bar is moved in the second direction such that the first male contact is separated from the first parallel contact, and the second conductor bar is moved in the second direction such that the second male contact is connected to the series contact and the third male contact is separated from the second parallel contact.

6. The battery switching device according to claim 1, wherein
the first contact device includes:
a first slider fixed to the first conductor bar;
a first ball screw screwed with the first slider; and
a first motor configured to rotate the first ball screw in accordance with a first signal for moving the first conductor bar in a direction in which the first male contact approaches the first parallel contact and a second signal for moving the first conductor bar in a direction in which the first male contact is separated from the first parallel contact,
the second contact device includes:
a second slider fixed to the second conductor bar;
a second ball screw screwed with the second slider; and
a second motor configured to rotate the second ball screw in accordance with a third signal for moving the second conductor bar in a direction in which the second male contact approaches the series contact and the third male contact is separated from the second parallel contact and a fourth signal for moving the second conductor bar in a direction in which the third male contact approaches the second parallel contact and the second male contact is separated from the series contact, and
the connection restriction unit includes:
a first switch configured to block the third signal output to the second motor while the first signal is input to the first motor;
a second switch configured to block the first signal output to the first motor while the third signal is input to the second motor;
a third switch configured to block the third signal output to the second motor while the first male contact is connected to the first parallel contact; and
a fourth switch configured to block the first signal output to the first motor while the second male contact is connected to the series contact.

7. The battery switching device according to claim 1, wherein
the first battery is connected to the first parallel contact, the series contact, and the second parallel contact,
the second battery is connected to the first movable contact and the second movable contact, and
the connection restriction unit includes:
a first fuse provided on a power line connecting the first parallel contact, the series contact, and the first battery; and
a second fuse provided on a power line connecting the first movable contact and the second battery.

8. The battery switching device according to claim 1, further comprising:
an insulating first shielding member disposed movably between a first shielding position for shielding the first parallel contact and a first open position for opening the first parallel contact;
an insulating second shielding member disposed movably between a second shielding position for shielding the series contact and a second open position for opening the series contact;
an insulating third shielding member disposed movably between a third shielding position for shielding the second parallel contact and a third open position for opening the second parallel contact;
a first driving mechanism configured to move the first shielding member from the first shielding position to the first open position in conjunction with movement of the first conductor bar in a direction in which the first male contact approaches the first parallel contact, and move the first shielding member from the first open position to the first shielding position in conjunction with movement of the first conductor bar in a direction in which the first male contact is separated from the first parallel contact; and
a second driving mechanism configured to move the second shielding member from the second shielding position to the second open position and move the third shielding member from the third open position to the third shielding position in conjunction with movement of the second conductor bar in a direction in which the second male contact approaches the series contact, and move the second shielding member from the second open position to the second shielding position and move the third shielding member from the third shielding position to the third open position in conjunction with movement of the second conductor bar in a direction in which the third male contact approaches the second parallel contact.
